(19) United States
(12) Patent Application Publication
(10) Pub. No.: US 2024/0179619 A1
(43) Pub. Date: May 30, 2024

(54) CONVERGED NETWORK ARCHITECTURE AND SIGNALING FOR WIRELESS NETWORK

(71) Applicant: Apple Inc., Cupertino, CA (US)

(72) Inventors: Peng Cheng, Beijing (CN); Behrouz Aghili, San Diego, CA (US); Fangli Xu, Beijing (CN); Haijing Hu, Los Gatos, CA (US); Naveen Kumar R. Palle Venkata, San Diego, CA (US); Ralf Rossbach, Munich (DE); Sudeep Manithara Vamanan, Nuremberg (DE); Vivek G. Gupta, San Jose, CA (US)

(73) Assignee: Apple Inc., Cupertino, CA (US)

(21) Appl. No.: 18/496,804

(22) Filed: Oct. 27, 2023

Related U.S. Application Data
(60) Provisional application No. 63/428,367, filed on Nov. 28, 2022.

(51) Int. Cl. H04W 48/18; H04W 60/04; H04W 60/06

(52) U.S. Cl. CPC H04W 48/18; H04W 60/04; H04W 60/06

(57) ABSTRACT

The present application relates to devices and components including apparatuses. systems. and methods for converged network architecture and signaling for wireless networks.

### RELATED APPLICATIONS

This application claims priority to U.S. Provisional Patent Application No. 63/428,367, filed Nov. 28, 2022, which is hereby incorporated by reference in its entirety.

### TECHNICAL FIELD

This application relates generally to communication networks and, in particular, to technologies for a converged network architecture and signaling for wireless network.

### BACKGROUND

Successive generations of Third Generation Partnership Project (3GPP) system architectures adapt to encompass new use cases, emerging technologies, and trends that impact overall network architecture and user equipment (UE) interaction.

### BRIEF DESCRIPTION OF THE DRAWINGS

FIG. 1 illustrates a network environment in accordance with some embodiments.

FIG. 2 illustrates components of the network environment in accordance with some embodiments

FIG. 3 illustrates a signaling diagram in accordance with some embodiments.

FIG. 4 illustrates signaling in accordance with some embodiments.

FIG. 5 illustrates a state-transition diagram in accordance with some embodiments.

FIG. 6 illustrates a signaling diagram of an initial registration in accordance with some embodiments.

FIG. 7 illustrates a signaling diagram of a mobility registration in accordance with some embodiments.

FIG. 8 illustrates a UE context change notification in accordance with some embodiments.

FIG. 9 is a service diagram of an mobility management function in accordance with some embodiments.

FIG. 10 is a service diagram of a connection management function in accordance with some embodiments.

FIG. 11 is a service diagram of a proxy function in accordance with some embodiments.

FIG. 12 is a service diagram of a UE context repository function in accordance with some embodiments.

FIG. 13 is a network environment with a one-tier deployment in accordance with some embodiments.

FIG. 14 is a network environment with a two-tier deployment in accordance with some embodiments.

FIG. 15 illustrates a signaling diagram for a registration procedure in accordance with some embodiments.

FIG. 16 illustrates a signaling diagram for a protocol data unit session establishment/modification procedure in accordance with some embodiments.

FIG. 17 illustrates a signaling diagram for a handover procedure in accordance with some embodiments.

FIG. 18 illustrates a signaling diagram for an initial registration procedure in accordance with some embodiments.

FIG. 19 illustrates a signaling diagram for a mobility/periodic registration procedure in accordance with some embodiments.

FIG. 20 illustrates a signaling diagram for a UE-triggered deregistration procedure in accordance with some embodiments.

FIG. 21 illustrates a signaling diagram for a network-triggered deregistration procedure in accordance with some embodiments.

FIG. 22 illustrates a signaling diagram for a protocol data unit (PDU) session establishment procedure in accordance with some embodiments.

FIG. 23 illustrates a signaling diagram for a PDU session modification procedure in accordance with some embodiments.

FIG. 24 illustrates a signaling diagram for a PDU session release procedure in accordance with some embodiments.

FIG. 25 illustrates a signaling diagram for a UE-triggered service request procedure in accordance with some embodiments.

FIG. 26 illustrates a signaling diagram for a network-triggered service request procedure in accordance with some embodiments.

FIG. 27 illustrates a signaling diagram for a handover procedure in accordance with some embodiments.

FIG. 28 illustrates an user equipment in accordance with some embodiments.

FIG. 29 illustrates a network node in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, and/or techniques in order to provide a thorough understanding of the various aspects of some embodiments. However, it will be apparent to those skilled in the art having the benefit of the present disclosure that the various aspects of the various aspects may be practiced in other examples that depart from these specific details. In certain instances, descriptions of well-known devices, circuits, and methods are omitted so as not to obscure the description of the various aspects with unnecessary detail. For the purposes of the present document, the phrase “A or B” means (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components, such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), and/or digital signal processors (DSPs), that are configured to provide the described functionality. In some aspects, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these aspects, the combination of hardware elements and program code may be referred to as a particular type of circuitry.

The term “processor circuitry.” as used herein refers to, is part of, or includes circuitry capable of sequentially and automatically carrying out a sequence of arithmetic or logical operations: or recording, storing, or transferring digital data. The term “processor circuitry” may refer an application processor: baseband processor: a central processing unit (CPU): a graphics processing unit: a single-core processor: a dual-core processor: a triple-core processor: a quad-core processor: or any other device capable of executing or otherwise operating computer-executable instructions, such as program code: software modules: or functional processes.

The term “interface circuitry” as used herein refers to, is part of, or includes circuitry that enables the exchange of information between two or more components or devices. The term “interface circuitry.” may refer to one or more hardware interfaces: for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to computer, storage, or network resources provided by physical hardware element(s). A “virtualized resource” may refer to computer, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element or a data element that contains content. An information element may include one or more additional information elements.

It may be desirable for a sixth generation (6G) system architecture to evolve to support an integrated network across air, ground, and space to provide ubiquitous communication services while being cognizant of industry trends in network disaggregation and intelligence. Evolved system architectures may open up the possibility of artificial intelligence (AI)-native enterprise-to-enterprise (E2E) intelligent network principles.

Boundaries between a radio access network (RAN) and core network (CN) are traditionally determined based on where specific functionality and contextual information are hosted. These boundaries may be reexamined in light of other emerging requirements and capabilities including, but not limited to, computing, perception, intelligence, coordination, and security that may extend E2E.

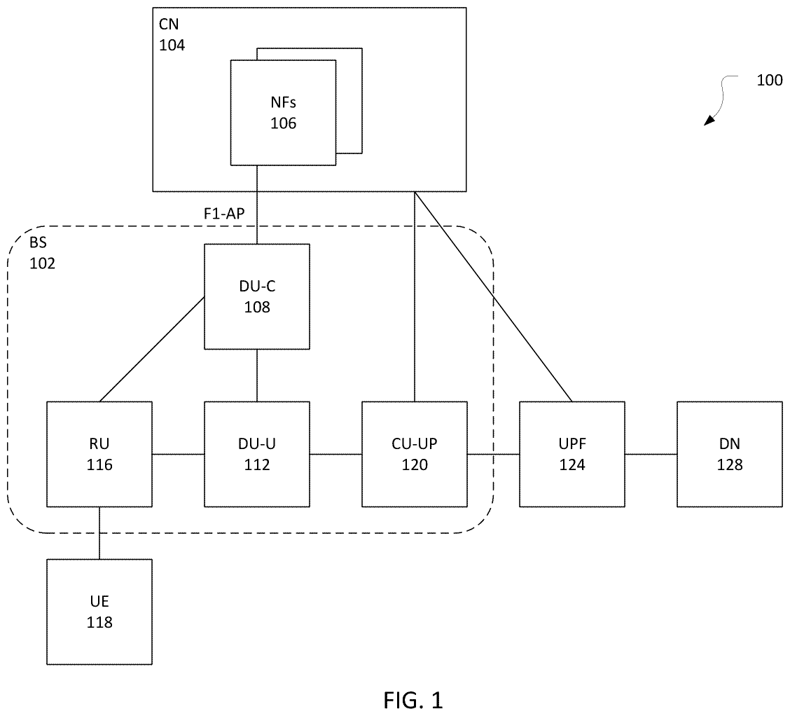

FIG. 1 illustrates a network environment 100 in accordance with some embodiments. The network environment 100 may include a core network (CN) 104. The CN 104 may provide a variety of network functions (NFs) 106 as will be described in further detail herein. The NFs 106 of the CN 104 may be designed to converge both traditional CN functions and higher-layer control plane functions typically associated with a centralized unit—control plane (CU-CP). This may enable the CN 104 to interface directly with a distributed unit—control plane node (DU-C) 108, which provides the lower-layer control plane functions. The CN 104 may be coupled with the DU-C 108 through a modified F1 application protocol (F1AP) interface that provides the NFs 106 with functionality related to discovery/exposure, request/response, and subscribe/notify as will be described in further detail herein.

The DU-C 108 may be coupled with both a distributed unit—user plane node (DU-U) 112 and a radio unit (RU) 116 that provides an air interface for a UE 118. The DU-U 112 may be coupled with a centralized unit—user plane node (CU-UP) 120. The DU-C 108, DU-U 112, the RU 116, and the CU-UP 120 may all be generally associated with a base station 102, although they may be distributed in separate devices.

The CU-UP 120 may be coupled with a user plane function (UPF) 124 that provides for routing and forwarding of user plane packets between the base station 102 and an external data network (DN) 128.

The architecture of the network environment 100 may be designed to resolve various shortcomings associated with 3GPP fifth generation (5G) networks. For example, the 5G network architecture relies on a strong interdependence between an access and mobility management function (AMF) and other NFs. This interdependence complicates introduction of new features in a modular plug-and-play manner. The 5G network architectures is also associated with significant redundancy between non-access stratum (NAS) and access stratum (AS) signaling. The mixed operation of computation and storage tasks distributed throughout NFs of 5G network architectures may also be associated with inefficiencies. For example, in the 5G network architecture, different UE contexts are stored and managed by different network nodes: the AS UE context by the CU-CP: the registration management (RM) UE context by the AMF: and the session management (SM) UE context by the session management function (SMF).

In the 5G network architecture, all core network functions depend on the AMF. For example, the AMF provides communication services for the policy control function (PCF), location management function (LMF), short message service function (SMSF), SMF, and peer AMF. The communication services may include UE mobility management (MM) contact management, transporting N1/N2 messages, allowing an NF to get AMF status changes, and supporting Long Term Evolution (LTE) interoperation. The AMF also provides event exposure services to the PCF, the unified data management (UDM), network exposure function (NEF), and the SMF. The event exposure services may enable an NF to subscribe and get notified about an event identifier (ID) associated with UE access and mobility information events. The AMF may provide mobile terminated (MT) services to the SMSF that allow the NF to request enabling UE reachability and paging, and domain selection of the Internet protocol multimedia services (IMS) voice to the consumer. The AMF may also provide location services to a gateway mobile location center (GMLC) to enable the NF to request location information for target UE.

Various functions in 5G network architectures are associated with repeated functionalities in both the RAN and the CN. These functions may include a mobility function, an authentication and key agreement (AKA) and authentication function, a NAS security command control function, an information transfer function, a connection management function, a session management function, and a data collection and analysis function.

The mobility function may include NAS procedures/messages (registration request/accept/complete/reject, deregistration request/accept) associated with AS procedures/messages (radio resource control (RRC) reconfiguration/RRC reestablishment/location measurement indication/failure information/location measurement configuration). The mobility function may further include NAS procedures/messages (configuration update command/complete) associated with AS procedures/messages (measurement report/sidelink UE information new radio (NR)/UE assistance information). The mobility function may also include identity request/response NAS procedures/messages.

The authentication and AKA function may include NAS procedures/messages (authentication request/response/failure/reject).

The NAS security command control function may include NAS procedures/messages (security mode command/complete/reject) associated with AS procedures/messages (security mode command/counter check/counter check response).

The information transfer function may include NAS procedures/messages (uplink (UL) NAS transport/downlink (DL) NAS transport) associated with AS procedures/messages (DL information transfer/UL information transfer).

The connection management function may include NAS procedures/messages (service request/accept/reject) associated with AS procedures/messages (RRC setup/RRC resume/RRC release/RRC reject). The connection management function may further include NAS paging procedures/messages associated with AS paging procedures/messages. The connection management function may further include NAS procedures/messages (notification/notification response) associated with AS procedures/messages (system information block (SIB)).

The session management function may include NAS procedures/messages related to: protocol data unit (PDU) session authentication command/complete: and UE-requested or network-requested PDU session/session modification/session release.

The data collection and analysis function may include NAS procedures/messages (Nnwdaf analytics-subscription subscribe/Nnwdaf analytics-subscription unsubscribe) associated with AS procedures/messages (non-real-time (RT) RAN intelligent controller (RIC), near-RT RIC (open-RAN (O-RAN))).

Embodiments of the present disclosure address the NF-interdependency shortcomings associated with the 5G network architecture by separating the AMF into three NFs: a proxy function (PF), a mobility management function (MMF), and a connection management function (CMF). The MMF includes measurement and AS configuration previously provided by the CU-CP.

Embodiments of the present disclosure additionally/alternatively address the NAS/AS redundancy shortcomings associated with the 5G network architecture by incorporating redundancies between NAS and AS (e.g., the mobility function) into one NF.

Embodiments of the present disclosure additionally/alternatively address the mixed operation of computation and storage by providing one NF, e.g., a UE context repository function (UCRF), with a high-speed interface to store and manage all the UE contexts including, for example, the AS UE context, the RM UE context, and the SM UE context.

Embodiments of the present disclosure additionally/alternatively describe extension of existing interface management messages of the F1 interface to support communication between a DU and the new service-based NF.

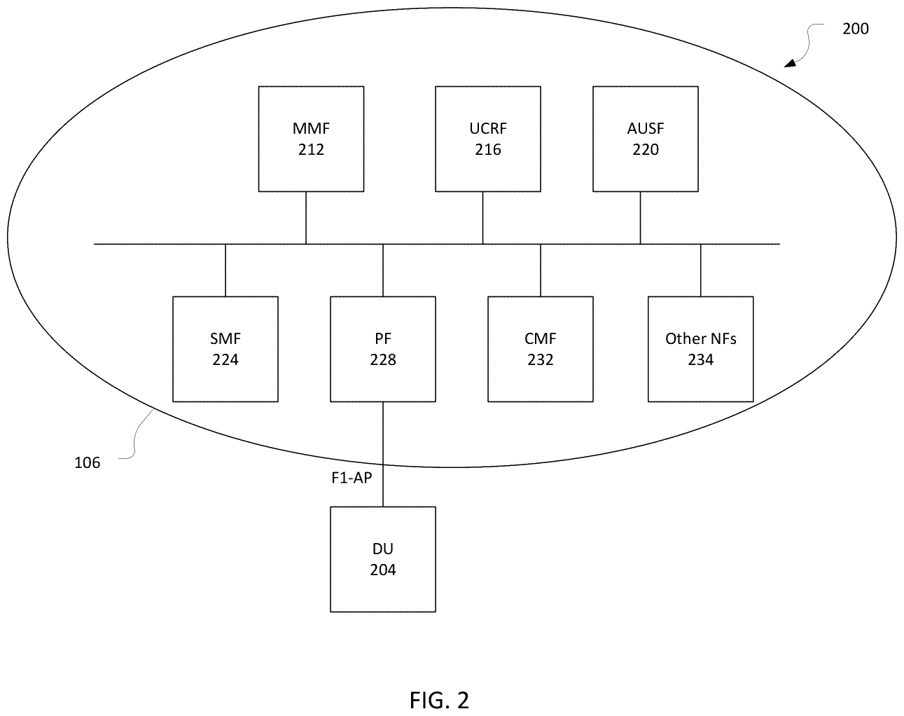

FIG. 2 illustrates components 200 of the network environment 100 in accordance with some embodiments. The components 200 may include the NFs 106 coupled with a DU 204. The DU 204 may correspond to DU-C 108 or DU-U 112 of FIG. 1.

The NFs 106 may include an MMF 212, a UCRF 216, an authentication server function (AUSF) 220, an SMF 224, a PF 228, a CMF 232, and other NFs 234.

Functionality previously found in the AMF or CU-CP is either incorporated into one or more of the NFs 106 or removed altogether as being unnecessary in the architecture of the network environment 100. For example, the UE MM context management of the AMF may be moved to the UCRF 216, the management of N1/N2 services of the AMF may not be needed as the N1/N2 interface may be replaced by a hypertext transfer protocol (HTTP)/2 interface, and the UE reachability and paging services provided to the SMSF/SMF may be handled by the CMF 232.

The PF 228 may perform NAS signaling proxy, NAS security functions, and access authentication and authorization functions previously provided by the AMF. The PF 228 may be coupled with the DU 204 via the enhanced F1 interface. In operation, the PF 228 may perform NF selection and forward NAS messages to corresponding NFs. The PF 228 may additionally/alternatively perform NAS ciphering and integrity protection operations. The PF 228 may perform the NAS security while the DU 204 performs AS security.

The mobility and radio resource configuration AS functions and mobility NAS functions provided by the AMF may be converged into a mobility management and radio resource provision/update function provided by the MMF 212, which may be responsible for mobility, radio resource management (RRM), and AS configuration services.

The authentication and AKA NAS functions of the AMF may be converged into an authentication function provided by the AUSF 220. The AUSF 220 may also provide a converged security control function to encompass the AS security mode control AS function and NAS security command control previously provided by the AMF. The packet data convergence protocol (PDCP), which was previously in the CU-CP, may be moved to the DU 204 to enable some AS security functions.

The connection management AS/NAS functions provided by the AMF may be converged into a connection management function of the CMF 232.

The UE capability AS function of the AMF may be converged into the UE capability function of the UCRF 216.

The session management NAS function provided by the AMF may be converged into a session management function of the SMF 224.

The information transfer AS/NAS functions provided by the AMF may be converged into a new information transfer function.

The minimization of drive tests (MDT) for data collection AS function and the data collection and analysis NAS function may be converged into a new data collection and AI function.

For example, the PF 228 may provide NAS signaling proxy services and NAS security, the CMF 232 may provide connection management, and the MMF may provide mobility, radio resource management (RRM) (e.g., radio resource provision/update), and AS configuration services.

The AUSF 220 may provide authentication and security control functions previously provided by the AMF.

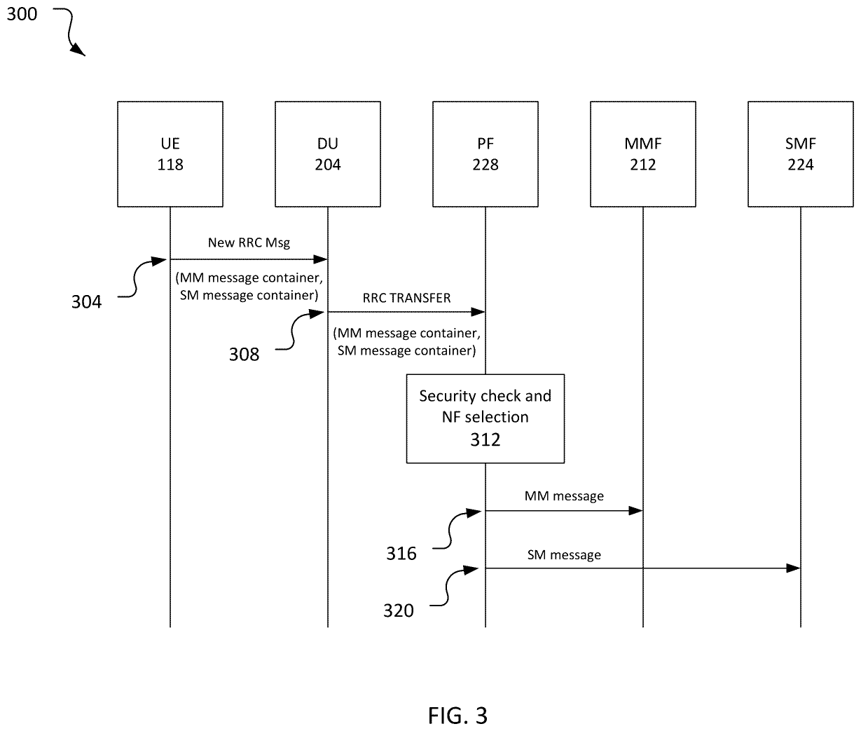

FIG. 3 is a signaling diagram 300 in accordance with some embodiments. The signaling diagram 300 may include signals and operations with respect to the UE 118, DU 204, PF 228, MMF 212, and SMF 224.

At 304, the UE 118 may transmit a message to the DU 204. The message may be an RRC message with a plurality of message containers. For example, the message may include an MM message container and an SM message container.

At 308, the DU 204 may transparently forward the message containers received from the UE 118 to the PF 228. In some embodiments, the DU 204 may forward the message containers in a transfer message such as, for example, an RRC transfer message.

At 312, the PF 228 may perform a security check on the RRC transfer message received from the DU 204. The security check may include a ciphering and integrity protection check. If the security check is successful, the PF 228 may perform an NF selection based on the content of the RRC transfer message. In some embodiments, the NF selection may additionally/alternative select an NF from a plurality of NFs of the same type based on proximity, load, etc. The PF 228 may decode the message at least in part, to determine the targeted NFs. In this example, the MM message container may include MM information to be transmitted to the MMF 212 and the SM message container may include SM information to be transmitted to the SMF 224.

At 316, the PF 228 may forward information from the MM message container to the MMF 212 in an MM message.

At 320, the PF 228 may forward information from the SM message container to the SMF 224 in an SM message. In some embodiments, the transmissions at 316 and 320 may be parallel transmissions. Parallel transmission, is referred to herein, may include a transmission that at least partially overlaps in time. By forwarding information from different message containers to corresponding NFs in parallel, the PF 228 may reduce signal latency associated with serial transmissions previously performed by an AMF.

While the signaling diagram 300 illustrate signals in the uplink direction, for example, from the UE 118 to the NFs, signals may be transmitted in a complementary manner in the downlink direction, for example, from the NFs to the UE 118.

Examples of the MM messages that may be exchanged between the MMF 212 and the PF 228 may include registration request/accept messages, deregistration request/accept messages: configuration update command/complete messages: authentication request/response messages: security mode command/complete messages: service request/accept messages: notification/notification response messages: and identity request/identity response messages.

Examples of SM messages that may be exchanged between the SMF 224 and the PF 228 may include PDU session authentication command/complete messages, UE-requested PDU session/network-requested PDU session messages: UE-requested PDU session/network-requested PDU session modification messages: UE-requested PDU session/network-requested PDU session release messages.

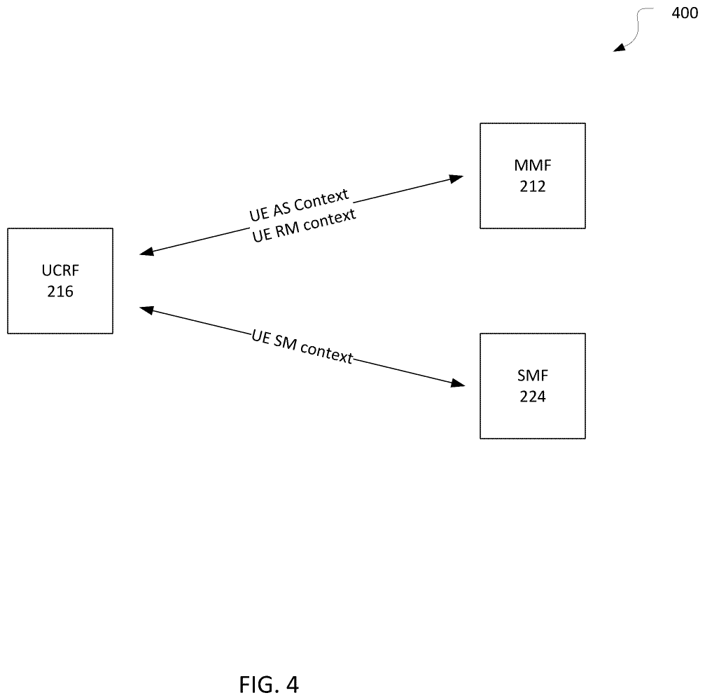

FIG. 4 illustrates signaling 400 between components of the network environment 100 in accordance with some embodiments. In particular, the signaling 400 may include signaling between the UCRF 416 and the MMF 412 and between the UCRF 416 and the SMF 424.

As mentioned above, the UCRF 216 may store and manage UE contexts including, for example, the UE AS context, the UE RM context, and the UE SM context. This may allow the reduction of the signaling required to exchange information on each NF's UE state. Further, the UCRF 216 storing and managing the UE contexts may increase system robustness. For example, if an old base station fails, a new base station may quickly find the desired UE context in the UCRF 216.

As shown in FIG. 4, the UCRF 216 may provide, upon request or detection of a predetermined event, the UE AS context or the UE RM context to the MMF 212 and the UE SM context to the SMF 224.

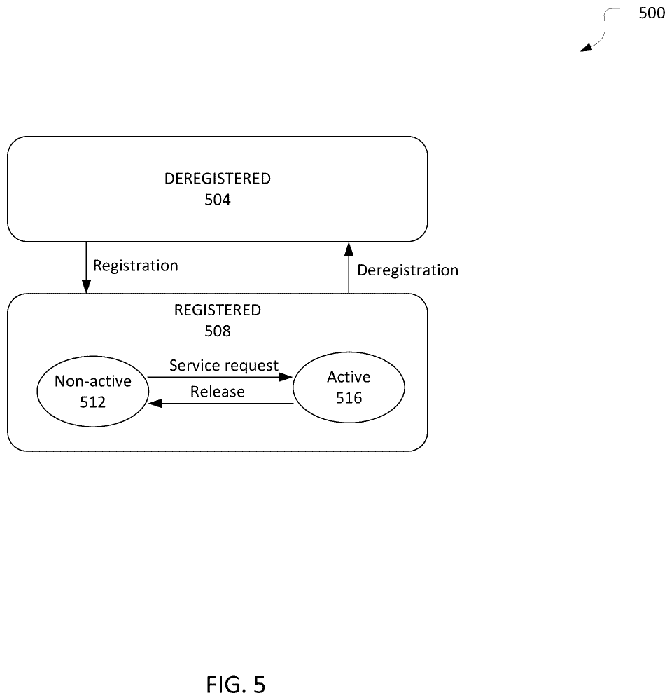

FIG. 5 illustrates a state-transition diagram 500 in accordance with some embodiments. The state-transition diagram 500 may represent transitions between states of the UE 118. Given that the CU-CP is merged with the MMF 212, the states of the UE 118 may be simplified to a deregistered state 504 and a registered state 508.

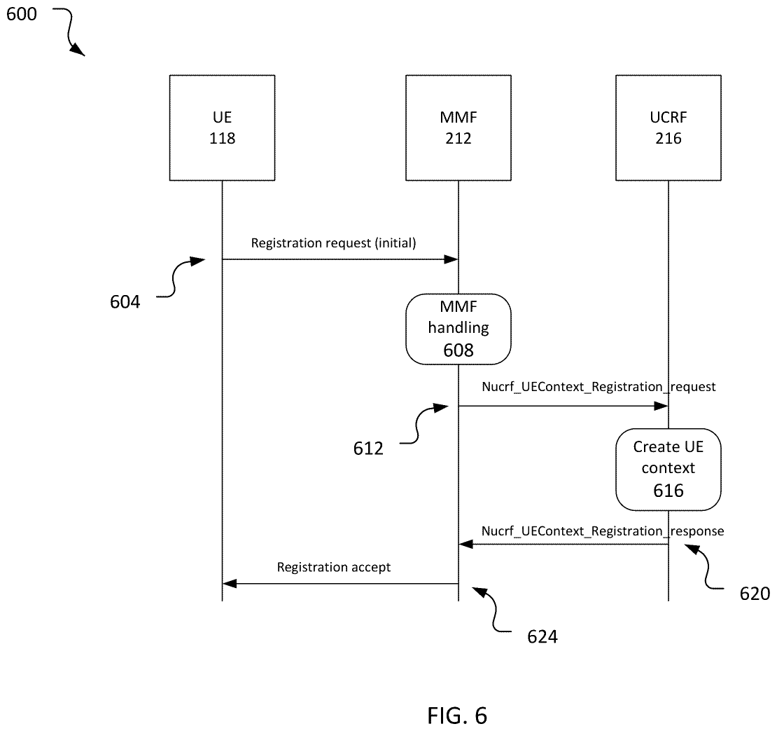

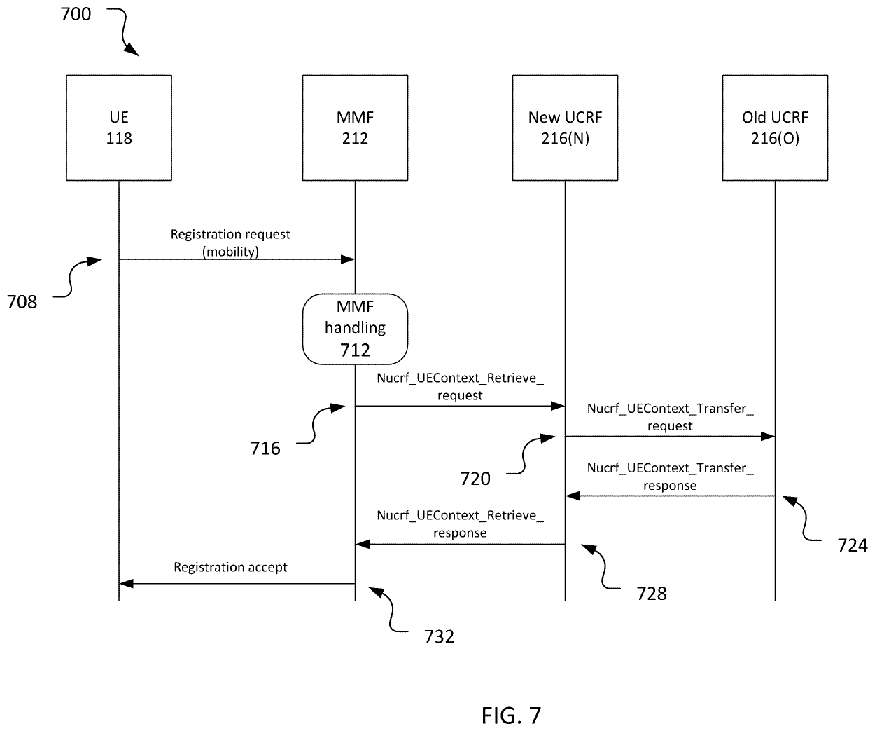

The UE 118 may start in the deregistered state 504. In the deregistered state 504, there may be no UE context stored in the UCRF 216. The UE 118 may transition to the registered state 508 by completing a registration process. Examples of registration processes are described with respect to FIGS. 6 and 7. If the UE 118 is in the registered state 508, the UCRF 216 may have a UE context stored therein.

There may be two substates of the registered state 508. A first substate may be referred to as an non-active substate 512 in which there is no on-going traffic and the UE 118 is without user-plane resources. The UE 118 may transition to the second substate, which may be referred to as an active substate 516, through a service request procedure with the MMF 212. In the active substate 516, the UE 118 may be engaged in on-going traffic and may be provided with user-plane resources. The UE 118 may transition from the active substate 516 to the non-active substate 512 by performing a release procedure with the MMF 212.

In addition to storing the UE contexts, the UCRF 216 may also store an indication of the present state/substate of the UE 118.

FIG. 6 is a signaling diagram 600 of an initial registration in accordance with some embodiments. The signaling diagram 600 may include operations and signals with respect to the UE 118, the MMF 212, and the UCRF 216.

At 604, the UE 118 may send a registration request to the MMF 212. The registration request may be for an initial registration.

At 608, the signaling diagram 600 may include MMF handling in which the MMF 212 processes the registration request and determines that a UE context may need to be created. The MMF 212 may generate a UE context registration request (Nucrf_UEContext_Registration_request) that is sent to the UCRF 216 at 612. The UE context registration request may include information the UCRF 216 uses to create a UE context at 616.

At 620, the UCRF 216 may provide a UE context registration response (Nucrf_UEContext_Registration_response) message to the MMF 212. The UE context registration response may include an indication of whether registration was successful including, for example, the generated UE context.

At 624, the MMF 212 may transmit a registration accept message to the UE 118 to complete the registration process.

FIG. 7 is a signaling diagram 700 a mobility registration in accordance with some embodiments. The signaling diagram 700 may include operations and signals with respect to the UE 118, the MMF 212, a new UCRF 216(N), and an old UCRF 216(O).

At 708, the UE 118 may send a registration request to the MMF 212. The registration request may be for a mobility registration. For example, the UE 118 may send the registration request as a result of a mobility event (for example, a mobility-triggered registration or handover).

At 712, the signaling diagram 700 may include MMF handling in which the MMF 212 processes the registration request and determines that a UE context may need to be retrieved. The MMF 212 may generate a UE context retrieve request (Nucrf_UEContext_Retrieve_request) that is sent to a new UCRF 216(N) at 716. The UE context retrieve request may include information the new UCRF 216(N) uses to identify the old UCRF 216(O) that has the UE context. In some embodiments, the UE context retrieve request may include a UE ID (for example, a 6G global unique temporary identifier (GUTI) or an international mobile subscriber identity (IMSI)) and a UE context type (for example, an RM context, an MM context, or an AS context).

At 720, the new UCRF 216(N) may transmit a UE context transfer request (Nucrf_UEContext_Transfer_request) to the old UCRF 216(O). The old UCRF 216(O) may then access the requested context and provide the context in a UE context transfer response (Nucrf_UEContext_Transfer_response) at 724

The new UCRF 216(N) may store the received context and, at 728, transmit a UE context retrieve response (Nucrf_UEContext_Retrieve_response) message to the MMF 212. The UE context retrieve response may include an indication of whether registration was successful including, for example, the retrieve UE context.

At 732, the MMF 212 may transmit a registration accept message to the UE 118 to complete the registration process.

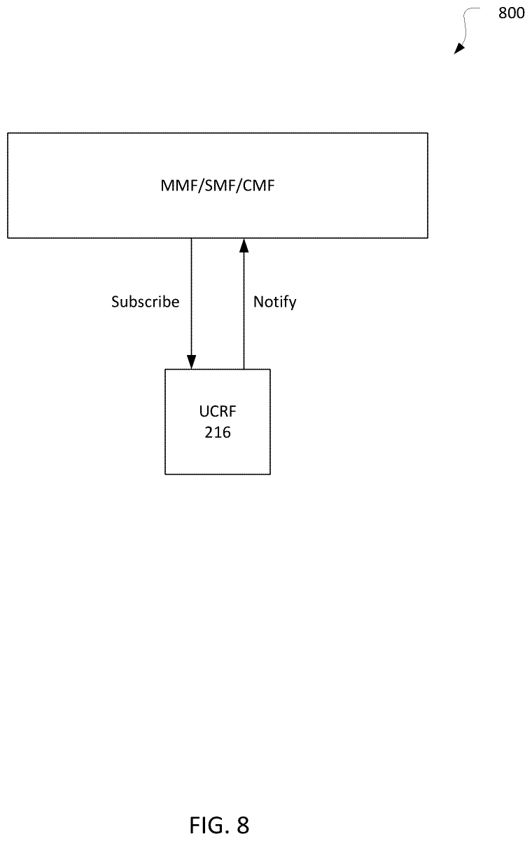

FIG. 8 illustrates a UE context change notification 800 in accordance with some embodiments. One or more NFs, for example, an MMF, SMF, or CMF, may subscribe with the UCRF for indications regarding changes to particular UE contexts. In some embodiments, the subscription request may include a UE ID and a context type. Upon detecting a change to a UE context with which at least one NF has subscribed for change notifications, the UCRF 216 may generate and transmit a notification message with an indication of the change to the interested NFs.

Referring again to FIG. 2, new signaling may be introduced for interface management by the enhanced F1-AP interface between the DU 204 and the PF 228. The signaling may include PF configuration/update signaling to configure/update the PF 228 for provision of proxy services.

In some embodiments, existing messages may be reused for air-interface related operations (for example, paging, SIB, and RRC message transfer). These messages may include, but are not limited to, paging messages, system information delivery messages, initial uplink RRC message transfer messages, downlink/uplink RRC message transfer messages, and RRC delivery reports.

As introduced above, the MMF 212 may be used for UE mobility management. The MMF 212 may perform various functions including some provided by the AMF or CU-CP in a 5G network architecture.

The functionalities provided by the MMF 212 may include registration/deregistration (from AMF): mobility management (at the registration area (RA) level or tracking area (TA) level (from AMF) or the cell level (from CU-CP)): measurements and radio resource configuration/update (from CU-CP); location service (from AMF), support for non-3GPP access networks (from AMF); and SIB generation (from CU-CP).

Table 1, below provides details of services provided by the MMF 212 in accordance with some embodiments.

TABLE 1

| Service Name | Service Operations | Operation semantics | Consumer |
|---|---|---|---|
| Nmmf_EventExposure | MMFStatusChangeSubscribe | Request/response | SMF, PCF, |
| | | | NEF, SMSF, |
| | | | UDM, UCRF |
| | MMFStatusChangeUnSubscribe | Request/response | SMF, PCF, |
| | | | NEF, SMSF, |
| | | | UDM, UCRF |
| | MMFStatusChangeNotify | Request/response | SMF, PCF, |
| | | | NEF, SMSF, |
| | | | UDM, UCRF |
| | Subscribe/Unsubscribe | Subscribe/notify | NEF, UCRF, |
| | | | UDM |
| | Notify | Subscribe/notify | NEF, UCRF, |
| | | | UDM |
| Nmmf_RRM | ConfigMeasurement/UpdateMeasurement/ | Request/response | SMF, CMF |
| | ReleaseMeasurement | | |
| | ProvideRadioResourceConfig/ | | |
| | UpdateRadioResourceConfig/ | | |
| | ReleaseRadioResourceConfig | | |
| Nmmf_Location | ProvidePositioningInfo/ | Request/response | 6G Positioning |
| | ProvideLocationInfo/CancelLocation | | NF |
| | EventNotify | Subscribe/notify | UDM, UCRF |

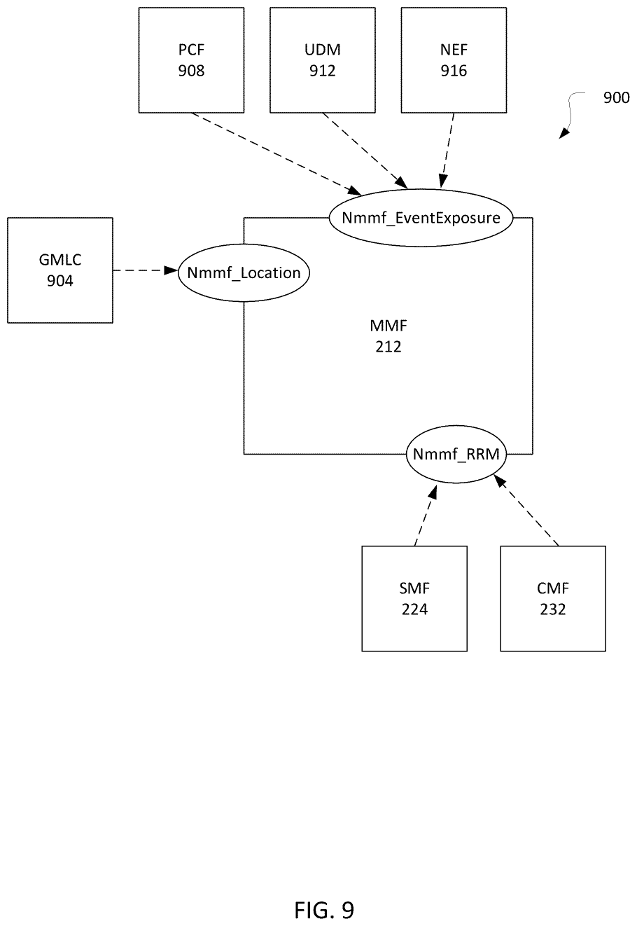

FIG. 9 is a service diagram 900 of the MMF 212 in accordance with some embodiments. The service diagram 900 illustrates a number of services exposed by the MMF 212 for the benefit of consumer NFs. The service diagram 900 is shown with some of the consumer NFs registered to various services. However, other consumers may also be included (as described, for example, in Table 1).

As shown, the service diagram 900 illustrates the MMF 212 providing: an Nmmf_location service for a GMLC 904, which may be one of the other NFs 234 of FIG. 2; an Nmmf_EventExposure service for a PCF 908, a UDM 912, and an NEF 916, which may be included in the other NFs 234 of FIG. 2; and an Nmmf_RRM service for the SMF 224 and the CMF 232.

The CMF 232 may provide UE connection management. The CMF 232 may be regarded as a converged NF to provide at least some functions previously provided by the AMF and at least some functions previously provided by the CU-CP. In particular, functionalities provided by the CMF 232 may include paging (from AMF and CU-CP) and notification (from AMF).

The CMF 232 may also enable the UE substate transitions between the non-

active substate 512 and the active substate 516.

Table 2, below provides details of services provided by the CMF 232 in accordance with some embodiments.

TABLE 2

| Service Name | Service Operations | Operation semantics | Consumer |
|---|---|---|---|
| Ncmf_Connection | EnableUEReachability | Request/response | SMF, SMSF |
| | UEReachabilityInfoNotify | Subscribe/Notify | SMF |
| Ncmf_EventExposure | Subscribe/Unsubscribe | Request/response | SMF |
| | Notify | Subscribe/notify | SMF |

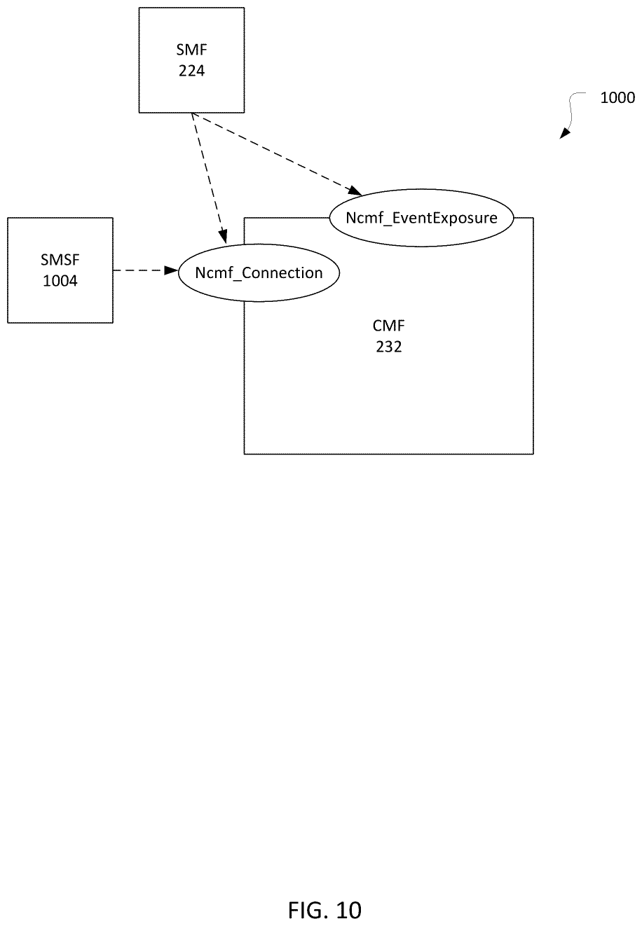

FIG. 10 is a service diagram 1000 of the CMF 232 in accordance with some embodiments. The service diagram 1000 illustrates a number of services exposed by the CMF 232 for the benefit of consumer NFs.

As shown, the service diagram 1000 illustrates the CMF 232 providing: an Nmmf_Connection service for the SMF 224 and an SMSF 1004, which may be one of the other NFs 234 of FIG. 2; and an Ncmf_EventExposure service for the SMF 224.

The PF 228 may be introduced as a unified proxy to route signals from the DU 204 to various NFs and vice versa. The PF 228 may be considered to provide the communication function previously associated with the AMF. The PF 228 may also provide NF selection and NAS ciphering and integrity protection as discussed elsewhere herein.

Table 3 below provides details of services provided by the PF 228 in accordance with some embodiments.

TABLE 3

| Service Name | Service Operations | Operation semantics | Consumer |
|---|---|---|---|
| Npf_Communication | NIMessageNotify | Request/response | PCF, LMF, |
| | | | Peer PF |
| | NIMessage Subscribe | Request/response | PCF |
| | NlMessage Transfer | Request/response | MMF, CMF, |
| | | | SMF, SMSF, |
| | | | PCF, LMF, |
| | | | UDM |
| | NITransferFailureNotification | Request/Response | MMF, CMF, |
| | | | SMF, SMSF, |
| | | | PCF, LMF, |
| | | | UDM |

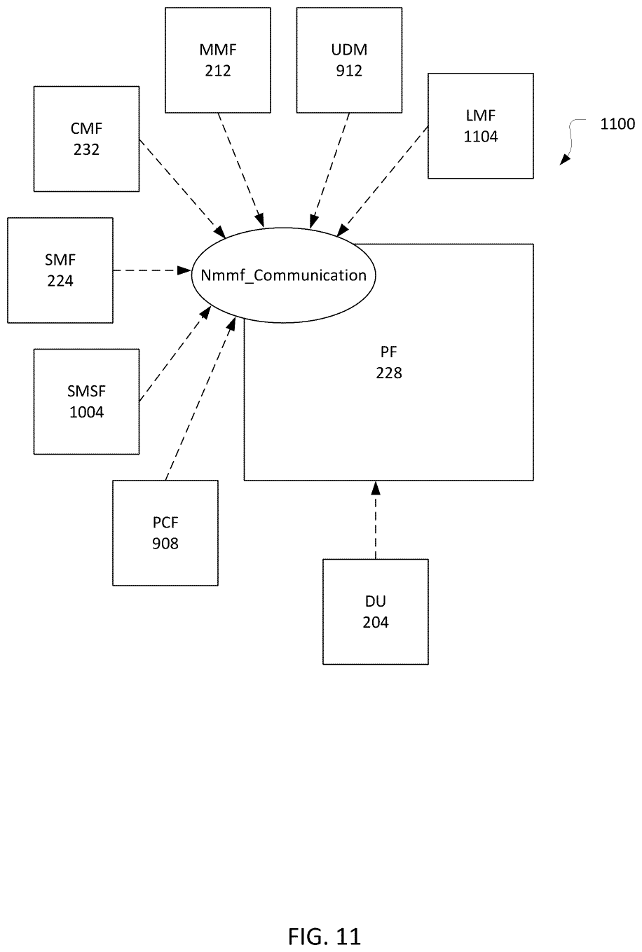

FIG. 11 is a service diagram 1100 of the PF 228 in accordance with some embodiments. The service diagram 1100 illustrates a number of services exposed by the PF 228 for the benefit of consumer NFs.

As shown, the service diagram 1100 illustrates the PF 228 providing an Npf_Communication service for the PCF 908, the SMSF 1004, the SMF 224, the CMF 232, the MMF 212, the UDM 912, and an LMF 1104, which may be one of the other NFs 234 of FIG. 2. The PF 228 may also be coupled with the DU 204.

The UCRF 216 may be introduced to handle UE context management. In particular, the UCRF 216 may serve to store, manage, retrieve, or transfer UE contexts (e.g., AS context, RM context, or SM context) and UE state/substates. The UCRF 216 may additionally/alternatively serve to expose UE context changes to consumer NFs (e.g., MMF, SMF, or CMF) as discussed above with respect to FIG. 8.

Table 4 below provides details of services provided by the UCRF 216 in accordance with some embodiments.

TABLE 4

| Service Name | Service Operations | Operation semantics | Consumer |
|---|---|---|---|
| Nucrf_UEContext | Registration | Request/response | MMF, CMF, |
| | | | SMF, PF |
| | Deregistration | Request/response | MMF, CMF, |
| | | | SMF, PF |
| | ContextTransfer | Request/response | Peer UCRF |
| | ContextUpdate | Request/Response | MMF, CMF, |
| | | | SMF, PF |
| | ContextRetrieve | Request/Response | MMF, CMF, |
| | | | SMF, PF |
| Nucrf_EventExposure | Subscribe/Unsubscribe | Subscribe/Notify | MMF, CMF, |
| | | | SMF, PF |
| | Notify | Subscribe/Notify | MMF, CMF, |
| | | | SMF, PF |

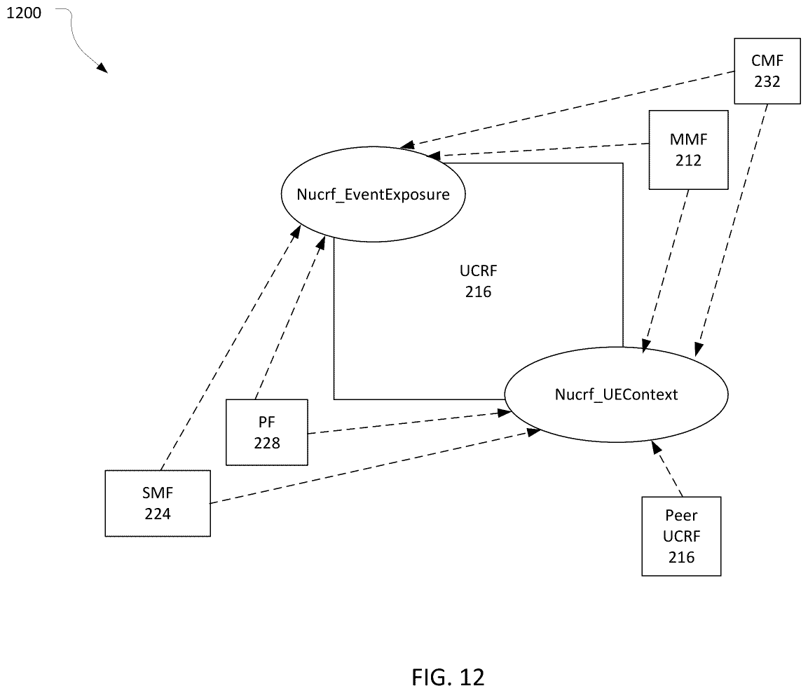

FIG. 12 is a service diagram 1200 of the UCRF 216 in accordance with some embodiments. The service diagram 1200 illustrates a number of services exposed by the UCRF 216 for the benefit of consumer NFs.

As shown, the service diagram 1200 illustrates the UCRF 216 providing an Nucrf_EventExposure service for the SMF 224, the PF 228, the MMF 212, and the CMF 232; and an Nucrf_UEContext service for the SMF 224, the PF 228, the MMF 212, the CMF 232, and a peer UCRF 216.

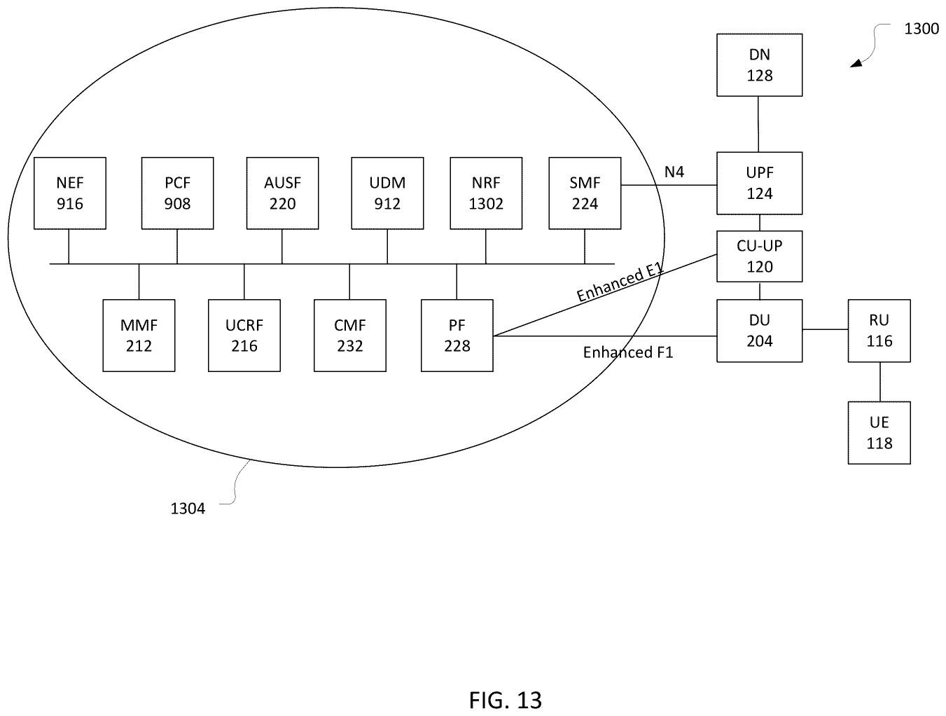

FIG. 13 is a network environment 1300 with a one-tier deployment in accordance with some embodiments. The individual components of the network environment 1300 may operate in a manner similar to described elsewhere herein.

The network environment 1300 may include a CN 1304 that includes a single service based architecture (SBA) deployment. The CN 1304 may include an NEF 916, PCF 908, AUSF 220, UDM 912, NRF 1302, SMF 224, MMF 212, UCRF 216, CMF 232, and PF 228. The NEF 916, PCF 908, AUSF 220, UDM 912, NRF 1302, and SMF 224 may be similar to like named-functions in current 5G network architectures. The new NFs of the CN 1304, for example, MMF 212, UCRF 216, CMF 232, and PF 228, may be deployed in a center cloud server.

The PF 228 may be coupled with DU 204 via an enhanced F1 interface and may be coupled with the CU-UP 120 via an enhanced E1 interface. The UPF 124 may be coupled with the SMF 224 via an N4 interface and may also be coupled with the CU-UP 120 and the DN 128. The DU 204 may be coupled with the RU 116, which may be coupled with the UE 118. While the CU-UP 120 is shown separately, in other embodiments, the CU-UP 120 may be merged with the DU 204 or the UPF 124.

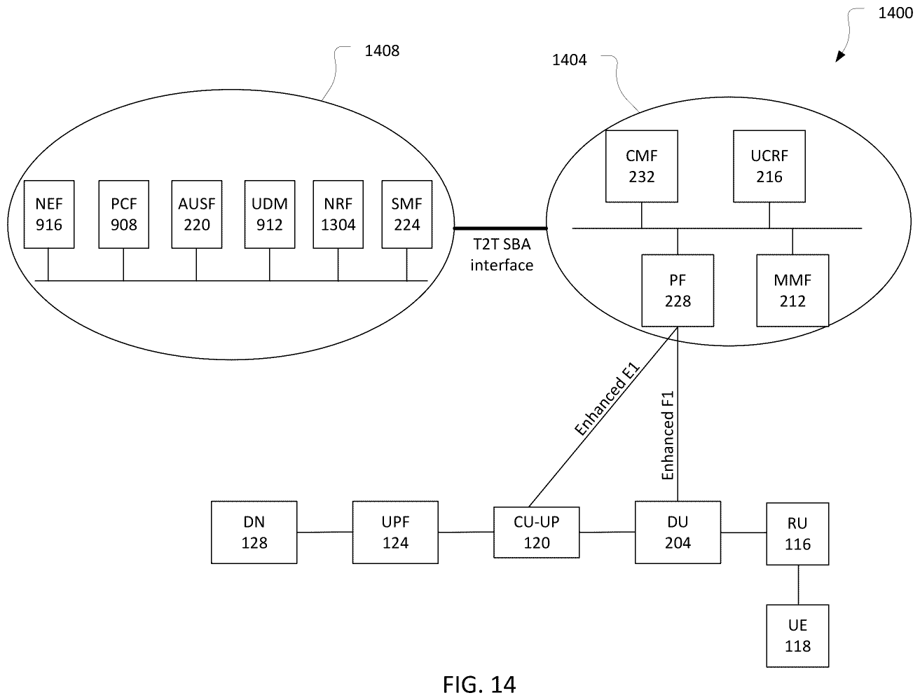

FIG. 14 is a network environment 1400 with a two-tier deployment in accordance with some embodiments. The individual components of the network environment 1400 may operate in a manner similar to described elsewhere herein.

The network environment 1400 may include a first tier 1404 that includes the new NFs, for example, MMF 212, UCRF 216, CMF 232, and PF 228. The first tier 1404 may be deployed close to the edge of the cloud network, e.g., close to components of the RAN to which the PF 228 is coupled, for example, DU 204 and CU-UP 120.

The network environment 1400 may also include a second tier 1408 that includes the other NFs, for example, NEF 916, PCF 908, AUSF 220, UDM 912, NRF 1302, and the SMF 224. The first tier 1404 may be coupled with the second tier 1408 via a tier-to-tier (T2T) SBA interface.

Similar to network environment 1300, the PF 228 may be coupled with the DU 204 via an enhanced F1 interface and may be coupled with the CU-UP 120 via an enhanced E1 interface. The UPF 124 may be coupled with the SMF 224 via an N4 interface and may also be coupled with the CU-UP 120 and the DN 128. The DU 204 may be coupled with the RU 116, which may be coupled with the UE 118. While the CU-UP 120 is shown separately, in other embodiments, the CU-UP 120 may be merged with the DU 204 or the UPF 124.

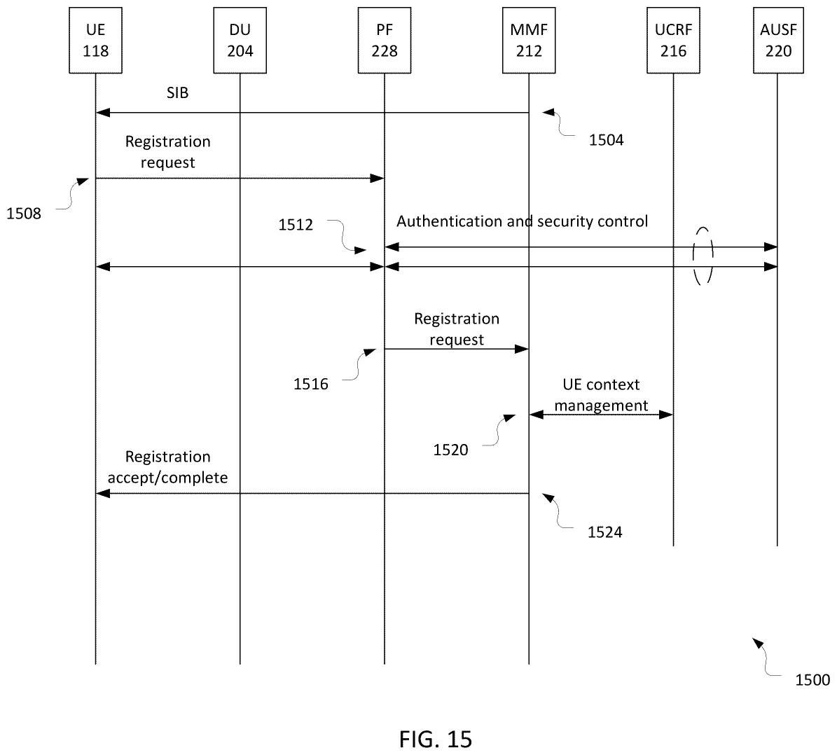

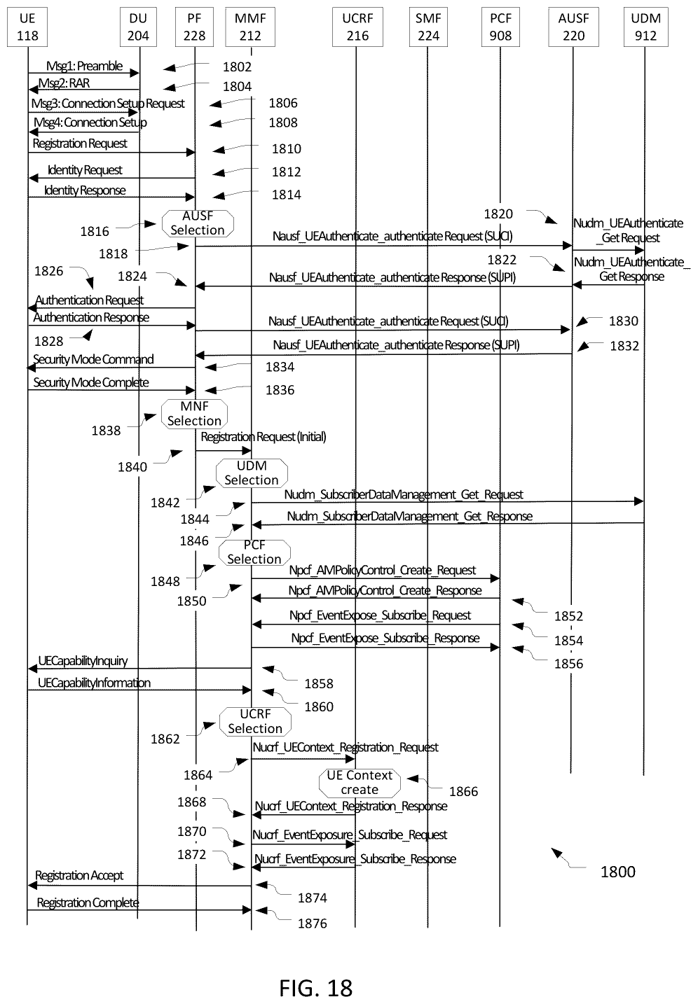

FIGS. 15-17 are signaling diagrams illustrating simplified signaling procedures with respect to registration, PDU session establishment/modification, and handover. FIGS. 18-27 are signaling diagrams illustrating more detailed signaling procedures in accordance with various embodiments. The procedures discussed with respect to FIGS. 15-27 involve signaling and operations with respect to various components/NFs described herein. Except as otherwise described herein, the messages and procedures described with respect to FIGS. 15-27 may be similar to like-named messages and procedures described in 3GPP Technical Specification (TS) 23.502 v17.6.0 (2022 Sep. 22).

FIG. 15 is a signaling diagram 1500 for a registration procedure in accordance with some embodiments.

At 1504, the MMF 212 may transmit system information in one or more SIB messages to the UE 118.

The UE 118 may decide to register with a network based on the SIB messages and, at 1508, may send a registration request to the PF 228.

At 1512, the PF 228 may perform an authentication and security control operation by exchanging one or more messages with the AUSF 220. The PF 228 may additionally exchange signals with the UE 118 as part of the authentication and security control operation.

Upon successful completion of the authentication and security control operation, the PF 228 may forward the registration request 1516 to the MMF 212.

The MMF 212 may perform a UE context management operation with the UCRF 216 at 1520. The MMF 212 may obtain the UE AS context or the UE RM context stored at the UCRF 216 as part of the UE context management operation. In some embodiments, if the registration is an initial registration, there may be no UE context in the UCRF 216. In this case, the MMF 212 may register a new UE context with the UCRF as part of the UE context management operation.

At 1524, the MMF 212 may send a registration accept/complete message to the UE 118 to convey a successful registration.

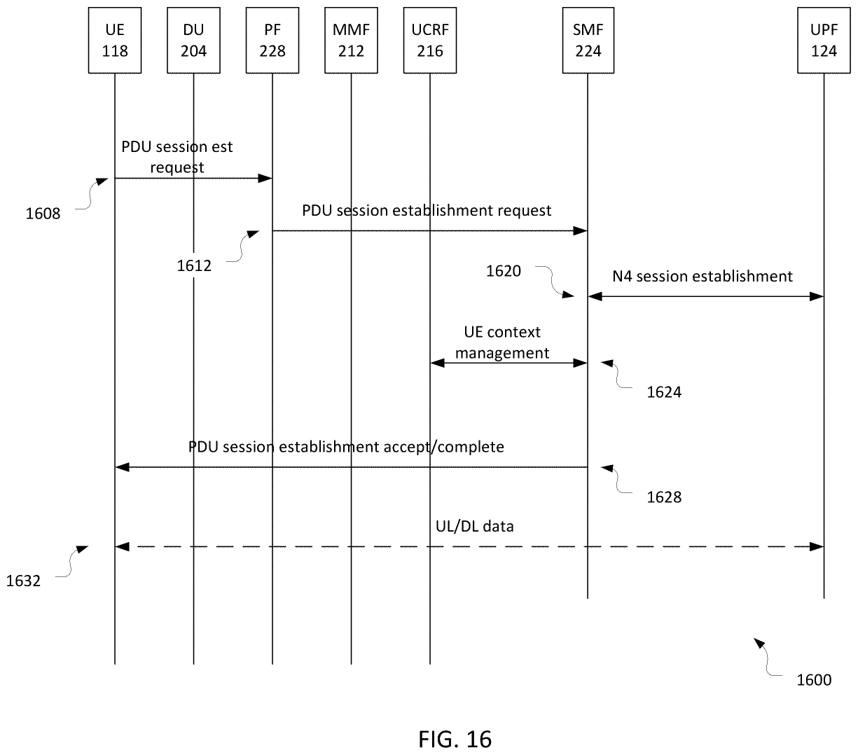

FIG. 16 is a signaling diagram 1600 for a PDU session establishment/modification procedure in accordance with some embodiments.

At 1608, the UE 118 may send a PDU session establishment request to the PF 228. The PF 228 may select an appropriate NF, e.g., SMF 224, and forward the PDU session establishment request to the SMF 224.

At 1620, the SMF 224 may engage with the UPF 124 for an N4 session establishment.

At 1624, the SMF 224 and the UCRF 216 may perform a UE context management. For example, the SMF 224 may retrieve a context associated with the UE 118 from the UCRF 216.

At 1628, the SMF 224 may transmit a PDU session establishment accept/complete message to the UE 118 via the PF 228. Upon successful establishment of the PDU session, the UE 118 may transmit uplink data to, and receive downlink data from, the UPF 124.

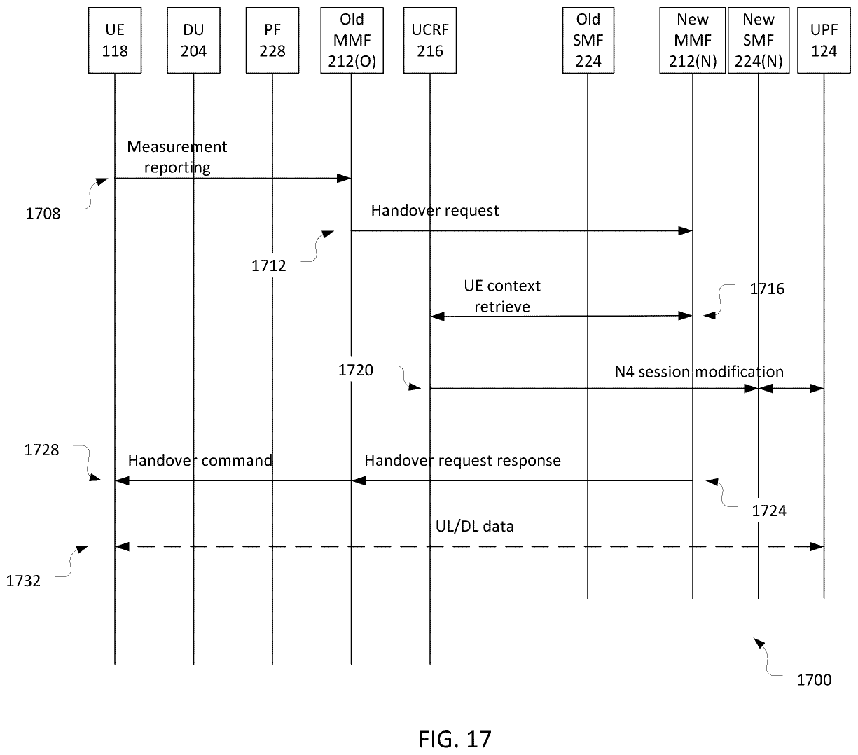

FIG. 17 is a signaling diagram 1700 for a handover procedure in accordance with some embodiments.

At 1708, the UE 118 may provide a measurement report to an old MMF 212(O). The measurement report may include results of measurements configured by the old MMF 212(O) for mobility purposes.

The old MMF 212(O) may trigger a handover based on the measurement report and identify a new MMF 212(N). The old MMF 212(O) may then send a handover request to the new MMF 212(N) at 1712.

At 1716, the new MMF 212(N) may retrieve a UE context from the UCRF 216.

The UCRF 216 may select an appropriate new SMF 224(N) based on proximity to the UE 118, load, etc. At 1720, the UCRF 216 may then send an N4 session modification message to the new SMF 224(N). The new SMF 224(N) may complete the N4 session modification with the UPF 124 to establish an N4 interface between the UPF 124 and the new SMF 224(N).

At 1724, the new MMF 212(N) may send the old MMF 212(O) a handover request response. The old MMF 212(O) may then send a handover command to the UE 118 at 1728 to complete the handover. After which, the UE 118 may transmit uplink data to, and receive downlink data from, the UPF 124 with services provided by the new SMF 224(N) and the new MMF 212(N).

FIG. 18 is a signaling diagram 1800 for an initial registration procedure in accordance with some embodiments.

At 1802, the UE 118 may send a message 1 preamble to the DU 204. The DU 204 may respond with a message 2 (msg2) random access response (RAR) at 1804. The UE 118 may then send a message 3 (msg3) connection setup request at 1806. The DU 204 may then send a message 4 (msg4) connection setup at 1808 to complete the random access channel (RACH) procedure.

At 1810, the UE 118 may send a registration request to the PF 228. The PF 228 may respond with an identity request at 1812. The UE 118 may then provide an identity response at 1814.

Upon receiving identity information from the UE 118 in the identity response, the PF 228 may perform an AUSF selection at 1816. At 1818, the PF 228 may send a UE 118 authentication request with a UE 118 identity (e.g., a subscription concealed identifier (SUCI)) to the selected AUSF 220. The AUSF 220 may send an authenticate get request to the UDM 912 at 1820 and the UDM 912 may respond with an authenticate get response at 1822. The AUSF 220 may then send a UE 118 authentication response at 1824 with a SUPI that is associated with the UE 118.

The PF 228 may send an authentication request to the UE 118 at 1826 and receive an authentication response from the UE 118 at 1828.

At 1830 and 1832, the PF 228 and the AUSF 220 may exchange additional authentication request/response messages. This may be followed by PF 228 sending a security mode command to the UE 118 at 1834 and receiving a security mode complete at 1836 when the UE 118 completes the security process.

At 1838, the PF 228 may perform an MMF 212 selection and, thereafter, send a registration request to the MMF 212 at 1840.

The MMF 212 may perform a UDM selection at 1842 and thereafter, send a subscriber data management get request at 1844. The UDM 912 may respond with a subscriber data management get response at 1846.

The MMF 212 may then perform a PCF selection at 1848 and thereafter, send an acknowledged mode (AM) policy control create request to the PCF 908 at 1850. The PCF 908 may respond with an AM policy control create response at 1852. The PCF 908 may send an event exposure subscribe request at 1854 to which the MMF 212 responds with an event exposure subscribe response at 1856.

At 1858, the MMF 212 may send a UE capability inquiry to the UE 118. The UE 118 may then respond with a UE capability information message at 1860.

The MMF 212 may then perform a UCRF 216 selection at 1862 and, thereafter, send a UE context registration request at 1864 to the UCRF 216. The UCRF 216 may create a UE context at 1866 and then respond with a UE context registration response at 1868.

At 1870, the MMF 212 may send an event exposure subscribe request to the UCRF 216 and the UCRF 216 may respond with an event exposure subscribe response 1872.

At 1874, the MMF 212 may send a registration accept message to the UE 118 and the registration process may then complete by the UE 118 sending the MMF 212 a registration complete message at 1876.

The initial registration procedure of FIG. 18 is associated with approximately 32 steps. An initial registration procedure of an existing 5G network architecture, on the other hand, requires approximately 44 steps. The reduction of steps be embodiments of the present disclosure may be enabled at least in part due to the merger of multiple NAS and AS messages and the use of the UCRF 216.

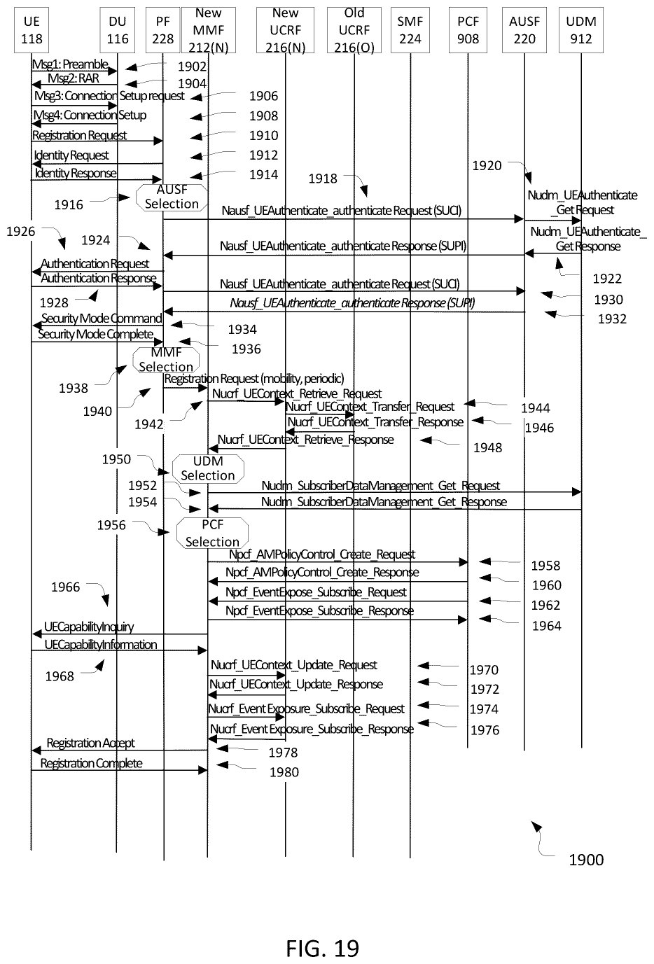

FIG. 19 is a signaling diagram 1900 for mobility/periodic registration procedure in accordance with some embodiments.

Operations/signals 1902-1936 may be similar to like-named operations/signals described above with respect to FIG. 18.

At 1938, the PF 228 may select the MMF 212 and send a registration request to the MMF 212 at 1940. The registration request may be trigger based on a mobility or periodic event.

At 1942, the MMF 212 may send a UE context retrieve request to a new UCRF 216. At 1944, the new UCRF 216(N) may send a UE context transfer request to an old UCRF 216(O), which responds with the requested UE context in a UE context transfer response sent at 1946. The new UCRF 216(N) may then send a UE context retrieve response to the MMF 212 at 1948.

The MMF 212 may perform a UDM selection at 1950 and thereafter, send a subscriber data management get request to the UDM 912 at 1952. The UDM 912 may respond with a subscriber data management get response at 1954.

The MMF 212 may then perform a PCF 908 selection at 1956 and thereafter, send an AM policy control create request to the PCF 908 at 1958. The PCF 908 may respond with an AM policy control create response at 1960. Afterwards, the PCF 908 may send an event exposure subscribe request at 1962 to which the MMF 212 responds with an event exposure subscribe response at 1964.

At 1966, the MMF 212 may send a UE capability inquiry to the UE 118. The UE 118 may then respond with a UE capability information message at 1968.

The MMF 212 may send a UE context update request to the UCRF 216 at 1970. The UCRF 216 may update the UE context and respond with a UE context updated response at 1972.

At 1974, the MMF 212 may send an event exposure subscribe request to the UCRF 216 and the UCRF 216 may respond with an event exposure subscribe response 1976.

At 1978, the MMF 212 may send a registration accept message to the UE 118 and the registration process may then complete by the UE 118 sending the MMF 212 a registration complete message at 1980.

The mobility/periodic registration procedure of FIG. 19 is associated with approximately 36 steps. A mobility/periodic registration procedure of an existing 5G network architecture, on the other hand, requires approximately 44 steps. The reduction of steps associated with embodiments of the present disclosure may be enabled, at least in part, due to the merger of multiple NAS and AS messages and the use of the UCRF 216.

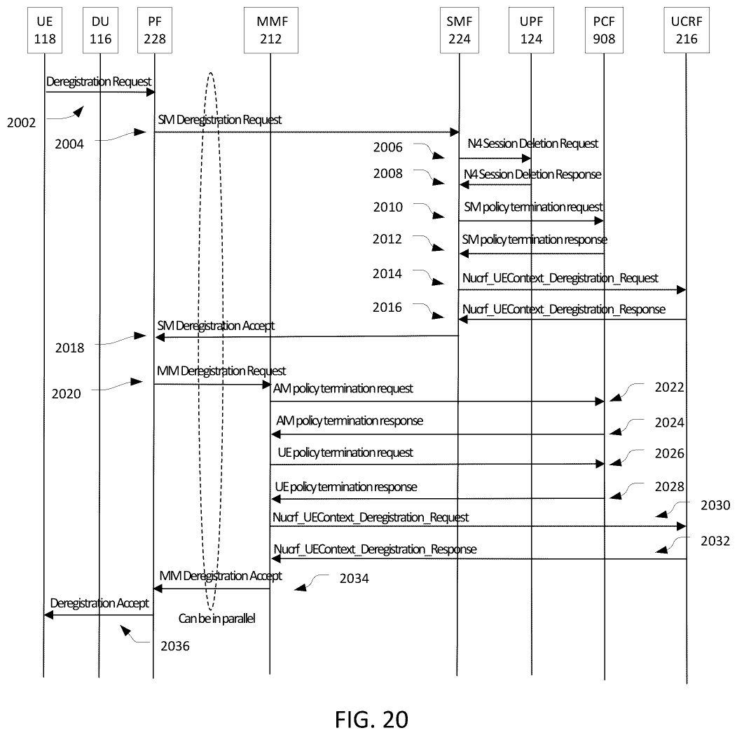

FIG. 20 is a signaling diagram 2000 for a UE-triggered deregistration procedure in accordance with some embodiments.

At 2002, the UE 118 may send a deregistration request to the PF 228. The PF 228 may then send an SM deregistration request to the SMF 224 at 2004. The SMF 224 may send an N4 session deletion request to the UPF 124 at 2006. The UPF 124 may response with an N4 session delete response at 2008.

At 2010, the SMF 224 may send an SM policy termination request to a PCF 908. The PCF 908 may respond by sending an SM policy termination response to the SMF 224 at 2012.

At 2014, the SMF 224 may send a UE context deregistration request to the UCRF 216. The UCRF 216 may respond by sending a UE context deregistration response to the SMF 224 at 2016.

At 2018, the SMF 224 may send an SM deregistration accept message to the PF 228.

At 2020, the PF 228 may send an MM deregistration request to the MMF 212. The MMF 212 may then send an AM policy termination request to the PCF 908 at 2022. The PCF 908 may respond by transmitting an AM policy termination response to the MMF 212 at 2024.

At 2026, the MMF 212 may send a UE 118 policy termination request to the PCF 908. The PCF 908 may respond by transmitting a UE 118 policy termination response to the MMF 212 at 2028.

At 2030, the MMF 212 may send a UE context deregistration request to the UCRF 216. The UCRF 216 may deregister the identified UE context and may respond by transmitting a UE context deregistration response to the MMF 212 at 2032.

At 2034, the MMF 212 may send an MM deregistration accept message to the PF 228.

At 2036, the PF 228 may send the UE 118 a deregistration accept message to complete the deregistration.

In some embodiments, the SM deregistration process (for example, messages 2002-2018) may be performed in parallel with the MM deregistration process (for example, messages 2020-2032).

The UE-triggered deregistration procedure of FIG. 20 is associated with approximately 10 steps. A UE-triggered deregistration procedure of an existing 5G network architecture, on the other hand, requires approximately 17 steps. The reduction of steps associated with embodiments of the present disclosure may be enabled, at least in part, due to the two pairs of NAS and AS messages being merged and due to the PF 228 forwarding MM and SM messages in parallel.

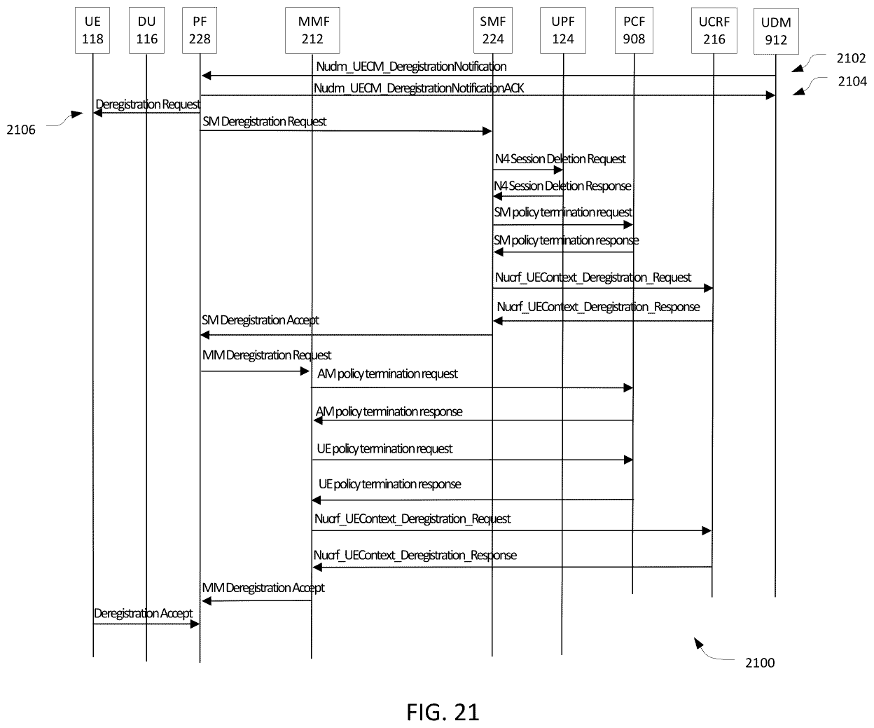

FIG. 21 is a signaling diagram 2100 for a network-triggered deregistration procedure in accordance with some embodiments.

At 2102, the UDM 912 may send a deregistration notification to the PF 228. The PF 228 may respond by sending a deregistration notification acknowledgment to the UDM 912 at 2104.

The PF 228 may then send a deregistration request to the UE 118 at 2106.

The remainder of the network-triggered deregistration procedure may include similar signals and operations described above with respect to the UE-triggered deregistration procedure of FIG. 20.

The network-triggered deregistration procedure of FIG. 21 is associated with approximately 12 steps. A network-triggered deregistration procedure of an existing 5G network architecture, on the other hand, requires approximately 19 steps. The reduction of steps associated with embodiments of the present disclosure may be enabled, at least in part, due to the two pairs of NAS and AS messages being merged and due to the PF 228 forwarding MM and SM messages in parallel.

It may be noted that only the UDM-triggered procedure is shown in FIG. 21. In other embodiments, other NFs of the network may trigger the deregistration.

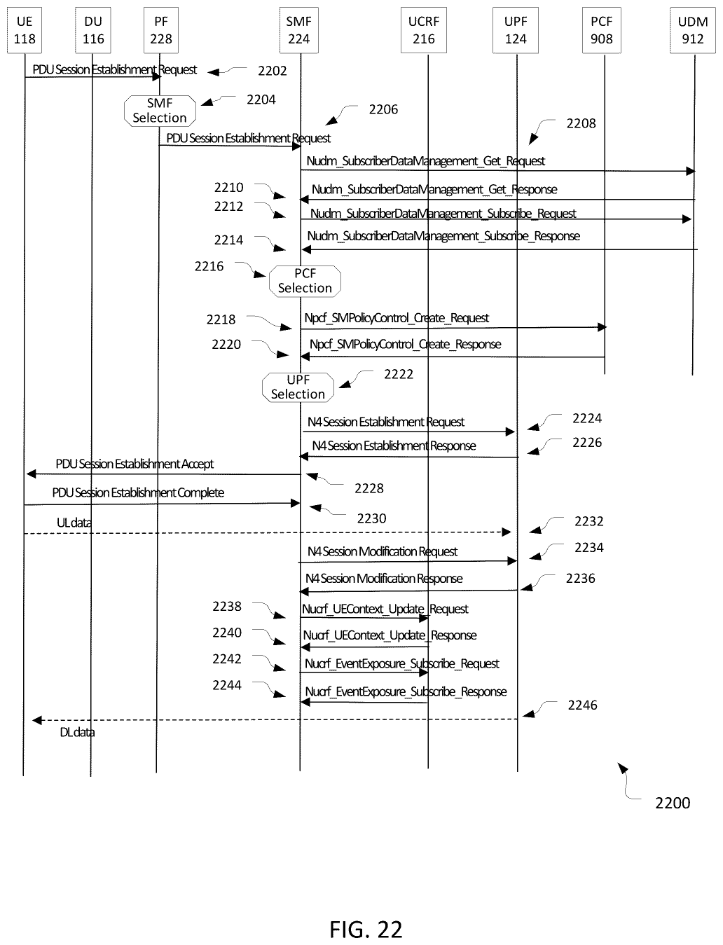

FIG. 22 is a signaling diagram 2200 for a PDU session establishment procedure in accordance with some embodiments.

At 2202, the UE 118 may send a PDU session establishment request to the PF 228. The PF 228 may perform an SMF 224 selection at 2204 and send a PDU session establishment request to the selected SMF 224 at 2206.

The SMF 224 may send a subscriber data management get request to the UDM 912 at 2208. The UDM 912 may respond by transmitting a subscriber data management get response to the SMF 224 at 2210.

The SMF 224 may send a subscriber data management subscribe request to the UDM 912 at 2212. The UDM 912 may respond by transmitting a subscriber data management subscribe response at 2214.

At 2216, the SMF 224 may perform a PCF 908 selection and send an SM policy control create request to the selected PCF 908 at 2218. The PCF 908 may respond by transmitting an SM policy control create response to the SMF 224 at 2220.

At 2222, the SMF 224 may perform a UPF 124 selection and send an N4 session establishment request to the selected UPF 124 at 2224. The UPF 124 may respond by transmitting an N4 session establishment response to the SMF 224 at 2226.

The SMF 224 may send a PDU session establishment accept message to the UE 118 at 2228. The UE 118 may respond by transmitting a PDU session establishment complete message to the SMF 224 at 2230. Thereafter, at 2232, an uplink data path may be established between the UE 118 and the UPF 124.

At 2234, the SMF 224 may send an N4 session modification request to the UPF 124. The UPF 124 may respond by transmitting an N4 session modification response to the SMF 224 at 2236.

At 2238, the SMF 224 may send a UE context update request to the UCRF 216. The UCRF 216 may respond by transmitting a UE context update response to the SMF 224 at 2240.

At 2242, the SMF 224 may send an event exposure subscribe request to the UCRF 216. The UCRF 216 may respond by transmitting an event exposure subscribe response to the SMF 224 at 2244. Thereafter, at 2246, a downlink data path may be established between the UPF 124 and that the UE 118.

The PDU session establishment procedure of FIG. 22 is associated with approximately 18 steps. A PDU session establishment procedure of an existing 5G network architecture, on the other hand, requires approximately 21 steps. The reduction of steps associated with embodiments of the present disclosure may be enabled, at least in part, due to the two pairs of NAS and AS messages being merged.

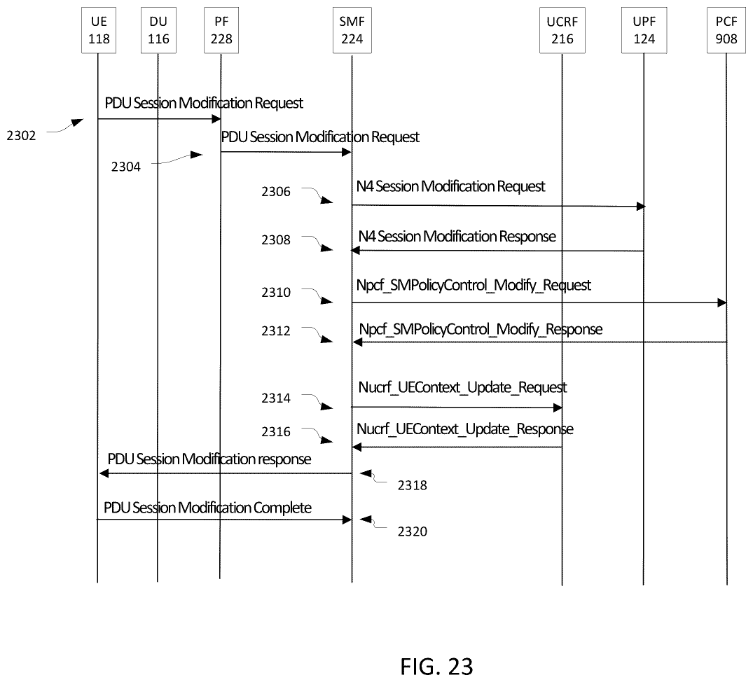

FIG. 23 is a signaling diagram 2300 for a PDU session modification procedure in accordance with some embodiments.

At 2302, the UE 118 may send a PDU session modification request to the PF 228. The PF 228 may send a PDU session modification request to an SMF 224 at 2304.

At 2306, the SMF 224 may send an N4 session modification request to the UPF 124. The UPF 124 may then respond with an N4 session modification response transmitted to the SMF 224 at 2308.

At 2310, the SMF 224 may transmit an SM policy control modify request to the PCF 908. The PCF 908 may respond by transmitting an SM policy control modify response to the SMF 224 at 2312.

At 2314, the SMF 224 may send a UE context update request to the UCRF 216. The UCRF 216 may then respond by transmitting a UE context update response to the SMF 224 at 2316.

At 2318, the SMF 224 may send a PDU session modification response to the UE 118. The process may complete by the UE 118 transmitting a PDU session modification complete message to the SMF 224 at 2320.

The PDU session modification procedure of FIG. 23 is associated with approximately 10 steps. A PDU session modification procedure of an existing 5G network architecture, on the other hand, requires approximately 20 steps. The reduction of steps associated with embodiments of the present disclosure may be enabled, at least in part, due to the two pairs of NAS and AS messages being merged and the removal of signaling on N2 modification.

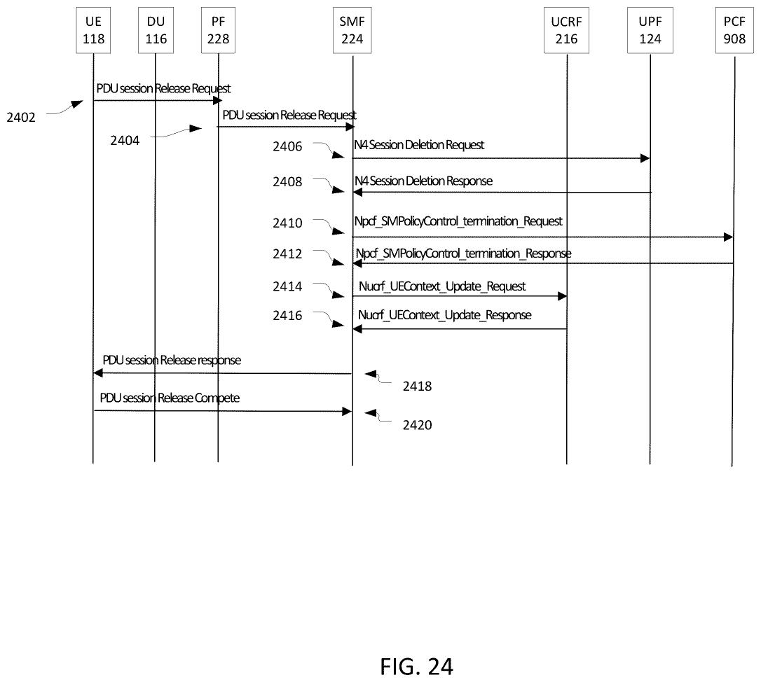

FIG. 24 is a signaling diagram 2400 for a PDU session release procedure in accordance with some embodiments.

At 2402, the UE 118 may send a PDU session release request to the PF 228. The PF 228 may send a PDU session modification request to an SMF 224 at 2404.

At 2406, the SMF 224 may send an N4 session deletion request to the UPF 124. The UPF 124 may then respond with an N4 session deletion response transmitted to the SMF 224 at 2408.

At 2410, the SMF 224 may transmit an SM policy control termination request to the PCF 908. The PCF 908 may respond by transmitting an SM policy control termination response to the SMF 224 at 2412.

At 2414, the SMF 224 may send a UE context update request to the UCRF 216. The UCRF 216 may then respond by transmitting a UE context update response to the SMF 224 at 2416.

At 2418, the SMF 224 may send a PDU session release response to the UE 118. The process may complete by the UE 118 transmitting a PDU session release complete message to the SMF 224 at 2420.

The PDU session release procedure of FIG. 24 is associated with approximately 10 steps. A PDU session release procedure of an existing 5G network architecture, on the other hand, requires approximately 19 steps. The reduction of steps associated with embodiments of the present disclosure may be enabled, at least in part, due to the two pairs of NAS and AS messages being merged and the removal of signaling on N2 release.

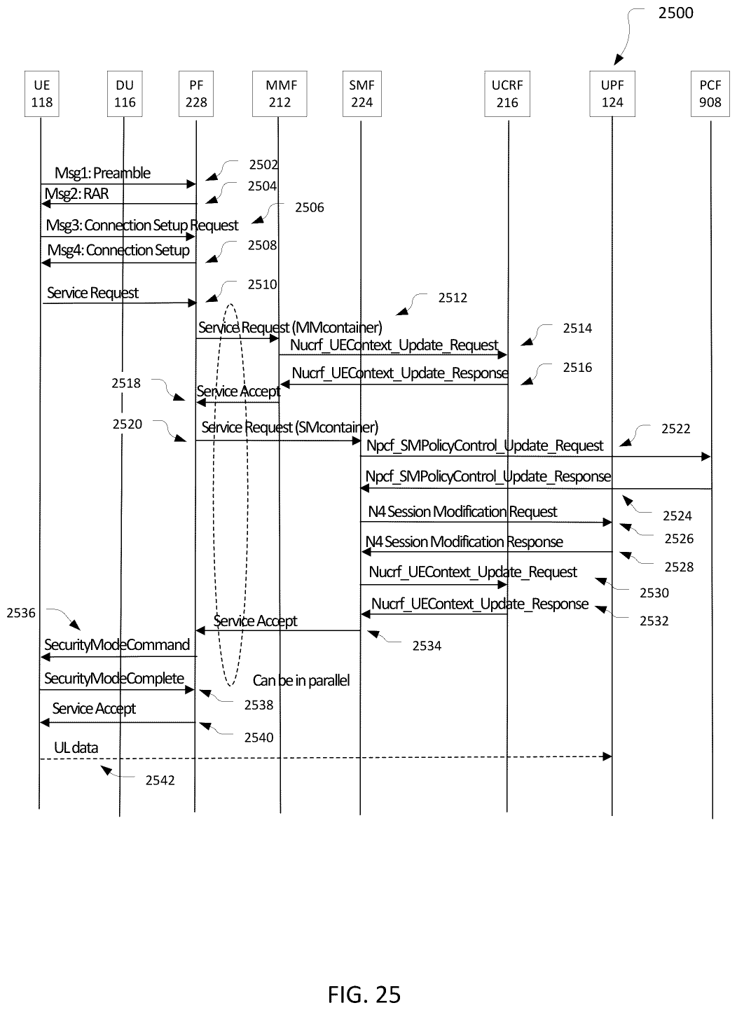

FIG. 25 is a signaling diagram 2500 for a UE-triggered service request procedure in accordance with some embodiments.

At 2502, the UE 118 may send a msg1 preamble to the DU 204. The DU 204 may respond with a msg2 RAR at 2504. The UE 118 may then send a msg3 connection setup request at 2506. The DU 204 may then send a msg4 connection setup at 2508 to complete the RACH procedure.

At 2510, the UE 118 may send a service request to the PF 228. The PF 228 may then select an MMF 212 and send the service request to the selected MMF 212 at 2512. The service request may include the MM container included in the service request received from the UE 118 (or information derived therefrom). At 2514, the MMF 212 may send a UE context update request to the UCRF 216. The UCRF 216 may then respond by sending a UE context update response to the MMF 212 at 2516. At 2518, the MMF 212 may send a service accept message to the PF 228.

At 2520, the PF 228 may select an SMF 224 and send a service request to the selected SMF 224. The service request may include the SM container included in the service request received from the UE 118 (or information derived therefrom). At 2522, the SMF 224 may send an SM policy control update request to the PCF 908. The PCF 908 may then respond by sending an SM policy control update response to the SMF 224 at 2524.

At 2526, the SMF 224 may send an N4 session modification request to the UPF 124. The UPF 124 may then respond by sending an N4 session modification response to the SMF 224 at 2528.

At 2530, the SMF 224 may send the UCRF 216 a UE context update request. The UCRF 216 may then respond by sending a UE context update response to the MMF 212 at 2532. At 2534, the MMF 212 may send a service accept message to the PF 228.

In some embodiments, the MM-based service request (for example, messages 2510-2518) may be performed in parallel with the SM-based service request (for example, messages 2520-2534).

At 2536, the PF 228 may send a security mode command to the UE 118. The UE 118 may then respond by transmitting a security mode complete message to the PF 228 at 2538. The PF 228 may send a security accept message to the UE 118 at 2540. After which, the UE 118 may have an uplink data path established with the UPF 124 at 2542.

The UE-triggered service request procedure of FIG. 25 is associated with approximately 16 steps. A UE-triggered service request procedure of an existing 5G network architecture, on the other hand, requires approximately 18 steps.

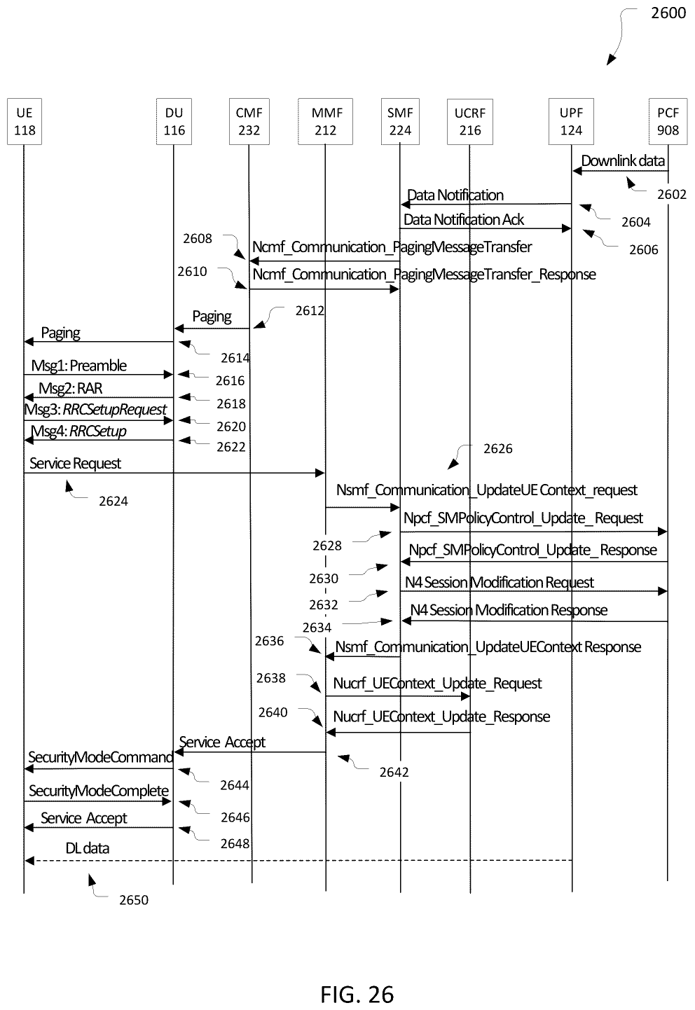

FIG. 26 is a signaling diagram 2600 for a network-triggered service request procedure in accordance with some embodiments.

At 2602, the UPF 124 may receive downlink data for the UE 118.

The UPF 124 may send a data notification to the SMF 224 at 2604. The SMF 224 may respond by sending a data notification ACK to the UPF 124 at 2606.

At 2608, the SMF 224 may send a communication paging message transfer to the CMF 232. The CMF 232 may then respond by sending a communication paging message transfer response at 2610.

At 2612, the CMF 232 may send a paging message to the DU 204, which the DU 204 may forward to the UE 118 at 2614.

At 2616, the UE 118 may send a mgs1 preamble to the DU 204. The DU 204 may respond with a msg2 RAR at 2618. The UE 118 may then send a msg3 connection setup request at 2620. The DU 204 may then send a msg4 connection setup at 2622 to complete the RACH procedure.

At 2624, the UE 118 may send a service request to the MMF 212. The MMF 212 may then send a communication update UE context request to the SMF 224 at 2626.

At 2628, the SMF 224 may send an SM policy control update request to the PCF 908. The PCF 908 may then respond by sending an SM policy control update response to the SMF 224 at 2630.

At 2632, the SMF 224 may send an N4 session modification request to the PCF 908. The PCF 908 may then response by sending an N4 session modification response at 2634.

At 2636, the SMF 224 may send an update UE context response to the MMF 212. The MMF 212 may then send an UE context update request to the UCRF 216 at 2638. The UCRF 216 may respond by sending a UE context update response to the MMF 212 at 2640.

The MMF 212 may send a service accept message to the DU 204 at 2642. The DU 204 may then send a security mode command to the UE 118 at 2644. The UE 118 may then respond by sending a security mode complete message to the DU 204 at 2646. The DU 204 may send a service accept message to the UE 118 at 2648. Thereafter, the UE 118 may have a downlink data path with the UPF 124 at 2650.

The network-triggered service request procedure of FIG. 26 is associated with approximately 24 steps. A network-triggered service request procedure of an existing 5G network architecture, on the other hand, requires approximately 25 steps. It may be noted that the core network paging and the RAN paging are merged in this embodiment.

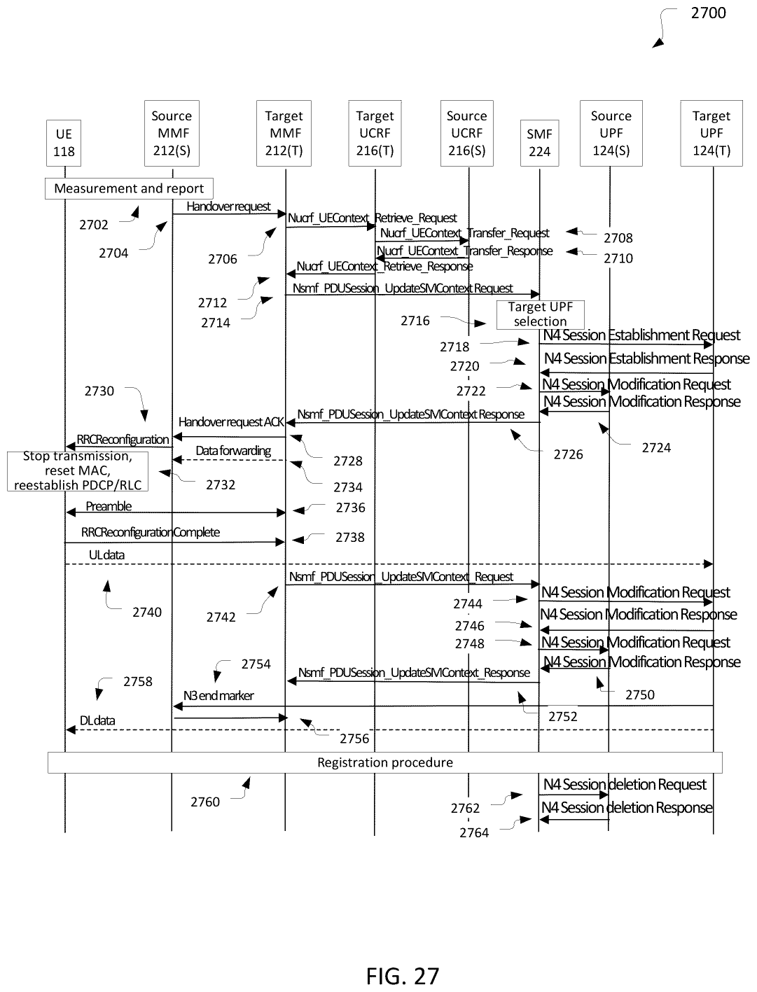

FIG. 27 is a signaling diagram 2700 for a handover procedure in accordance with some embodiments.

At 2702, the UE 118 and the source MMF 212(S) may engage in a measurement and report procedure. Measurements may be performed by the UE 118 based on measurements configured by the source MMF 212.

At 2704, the source MMF 212(S) may send a handover request to a target MMF 212(T). The target MMF 212(T) may then send a UE context retrieve request to the target UCRF 216(T) at 2706. The target UCRF 216(T) may then send a UE context transfer request to the source UCRF 216(S) at 2708. The source UCRF 216(S) may respond by providing the requested UE context to the target UCRF 216(T) in a UE context transfer response message at 2710. The target UCRF 216(T) may then transmit the UE context to the target MMF 212(T) in a UE context retrieve response at 2712.

At 2714, the target MMF 212(T) may send a PDU session update SM context request to the SMF 224. The SMF 224 may select a target UPF 124(T) at 2716 and may then transmit an N4 session establishment request to the selected UPF 124 at 2718. The target UPF 124(T) may respond by sending an N4 establishment response to the SMF 224 at 2720.

At 2722, the SMF 224 may send an N4 session modification request to the source UPF 124(S). The source UPF 124(S) may respond by transmitting an N4 session modification response to the SMF 224 at 2724. The SMF 224 may transmit a PDU session update SM context response to the target MMF 212(T) at 2726. The target MMF 212(T) may send a handover request ACK to the source MMF 212(S) at 2728. The source MMF 212(S) may then send an RRC reconfiguration to the UE 118 at 2730.

At 2732, the UE 118 may stop any ongoing transmission, reset MAC, and reestablish PDCP/RLC connection. The target MMF 212(T) may also be forwarding data to the source MMF 212 at 2734.

At 2736, the UE 118 and target MMF 212(T) may exchange preambles and the UE 118 may send an RRC reconfiguration complete message to the target MMF 212(T) at 2738.

At 2740, the UE 118 may be able to transmit uplink data to the target UPF 124(T).

At 2742, the target MMF 212(T) may send a PDU session update SM context request to the SMF 224. The SMF 224 may then send an N4 session modification request to the target UPF 124(T) at 2744. The target UPF 124(T) may respond by sending an N4 session modification response at 2746.

At 2748, the SMF 224 may send an N4 modification request to the source UPF 124(S). The source UPF 124(S) may then respond by sending an N4 session modification response to the SMF 224 at 2750.

At 2752, the SMF 224 may send a PDU session update SM context response to the target MMF 212(T).

At 2754, the target UPF 124(T) may send an N3 end marker to the source MMF 212(S). The source MMF 212(S) may then include the N3 end marker in user plane traffic towards the target MMF 212(T) at 2756. Thereafter, the UE 118 may have a DL connection at 2758 for DL data transmissions from the target UPF 124(T) to the UE 118.

At 2760, a registration procedure may be performed. After a successful registration procedure, the SMF 224 may send an N4 session deletion request to the source UPF 124(S) at 2762. The source UPF 124(S) may then respond by sending an N4 session deletion response to the SMF 224 at 2764.

The handover procedure of FIG. 27 is associated with approximately 21 steps. The handover procedure of FIG. 27 represents the merger of Xn-based and N2-based handover procedures of an existing 5G network architecture. The Xn-based handover procedure requires approximately 14 steps, while the N2-based handover procedure requires approximately 30 steps. The reduction of steps associated with embodiments of the present disclosure may be enabled, at least in part, due to the target and number being able to directly retrieve the UE context from the UCR and the removal of N2 signaling.

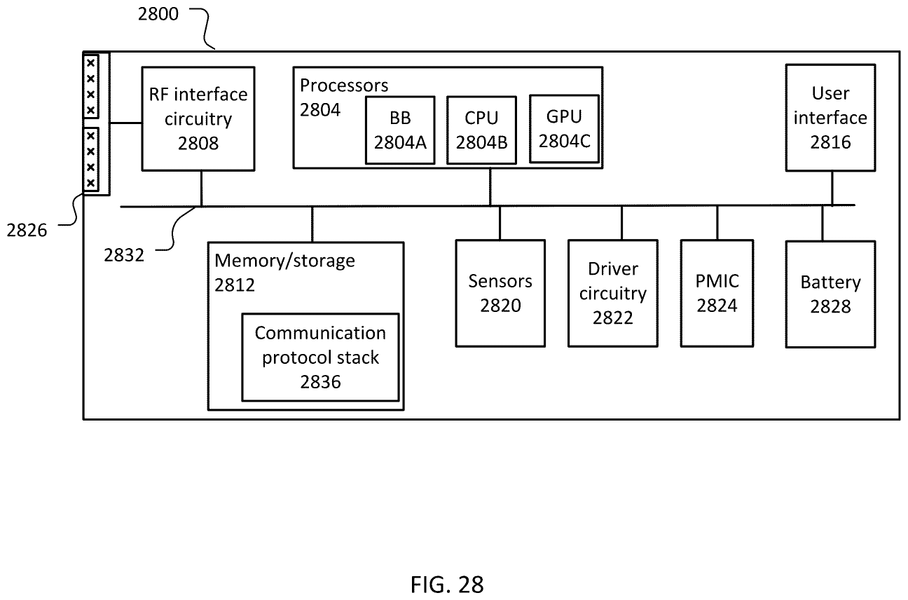

FIG. 28 illustrates a UE 2800 in accordance with some embodiments. The UE 2800 may be similar to, and substantially interchangeable with, UE 118 of FIG. 1.

The UE 2800 may be any mobile or non-mobile computing device, such as, for example, a mobile phone, computer, tablet, XR device, glasses, industrial wireless sensor (for example, microphone, carbon dioxide sensor, pressure sensor, humidity sensor, thermometer, motion sensor, accelerometer, laser scanner, fluid level sensor, inventory sensor, electric voltage/current meter, or actuator), video surveillance/monitoring device (for example, camera or video camera), wearable device (for example, a smart watch), or Internet-of-things device.

The UE 2800 may include processors 2804, RF interface circuitry 2808, memory/storage 2812, user interface 2816, sensors 2820, driver circuitry 2822, power management integrated circuit (PMIC) 2824, antenna structure 2826, and battery 2828. The components of the UE 2800 may be implemented as integrated circuits (ICs), portions thereof, discrete electronic devices, or other modules, logic, hardware, software, firmware, or a combination thereof. The block diagram of FIG. 28 is intended to show a high-level view of some of the components of the UE 2800. However, some of the components shown may be omitted, additional components may be present, and different arrangement of the components shown may occur in other implementations.

The components of the UE 2800 may be coupled with various other components over one or more interconnects 2832, which may represent any type of interface, input/output, bus (local, system, or expansion), transmission line, trace, or optical connection that allows various circuit components (on common or different chips or chipsets) to interact with one another.

The processors 2804 may include processor circuitry such as, for example, baseband processor circuitry (BB) 2804A, central processor unit circuitry (CPU) 2804B, and graphics processor unit circuitry (GPU) 2804C. The processors 2804 may include any type of circuitry or processor circuitry that executes or otherwise operates computer-executable instructions, such as program code, software modules, or functional processes from memory/storage 2812 to cause the UE 2800 to perform operations as described herein.

In some embodiments, the baseband processor circuitry 2804A may access a communication protocol stack 2836 in the memory/storage 2812 to communicate over a 3GPP compatible network. In general, the baseband processor circuitry 2804A may access the communication protocol stack 2836 to: perform user plane functions at a PHY layer, MAC layer, RLC sublayer, PDCP sublayer, SDAP sublayer, and upper layer; and perform control plane functions at a PHY layer, MAC layer, RLC sublayer, PDCP sublayer, RRC layer, and a NAS layer. In some embodiments, the PHY layer operations may additionally/alternatively be performed by the components of the RF interface circuitry 2808.

The baseband processor circuitry 2804A may generate or process baseband signals or waveforms that carry information in 3GPP-compatible networks. In some embodiments, the waveforms for NR may be based cyclic prefix OFDM (CP-OFDM) in the uplink or downlink, and discrete Fourier transform spread OFDM (DFT-S-OFDM) in the uplink.

The memory/storage 2812 may include one or more non-transitory, computer-readable media that includes instructions (for example, communication protocol stack 2836) that may be executed by one or more of the processors 2804 to cause the UE 2800 to perform various operations described herein. The memory/storage 2812 include any type of volatile or non-volatile memory that may be distributed throughout the UE 2800. In some embodiments, some of the memory/storage 2812 may be located on the processors 2804 themselves (for example, L1 and L2 cache), while other memory/storage 2812 is external to the processors 2804 but accessible thereto via a memory interface. The memory/storage 2812 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology. The memory/storage 2812 may include a SIM/USIM in some embodiments.

In some embodiments, the UE 2800 may include a UICC that is removably coupled with platform circuitry of the UE 2800 through, for example, a card slot. The UICC may include portions of the processors 2804 and memory/storage 2812. The memory/storage may include a SIM/USIM having SENSE values stored thereon. In other embodiments, the components of the UICC may be integrated directly into (e.g., permanently coupled with) the platform circuitry of the UE 2800.

The RF interface circuitry 2808 may include transceiver circuitry and radio frequency front module (RFEM) that allows the UE 2800 to communicate with other devices over a radio access network. The RF interface circuitry 2808 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna structure 2826 and proceed to filter and amplify (with a low-noise amplifier) the signal. The signal may be provided to a receiver of the transceiver that down-converts the RF signal into a baseband signal that is provided to the baseband processor of the processors 2804.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna structure 2826.

In various embodiments, the RF interface circuitry 2808 may be configured to transmit/receive signals in a manner compatible with NR access technologies.

The antenna structure 2826 may include antenna elements to convert electrical signals into radio waves to travel through the air and to convert received radio waves into electrical signals. The antenna elements may be arranged into one or more antenna panels. The antenna structure 2826 may have antenna panels that are omnidirectional, directional, or a combination thereof to enable beamforming and multiple input, multiple output communications. The antenna structure 2826 may include microstrip antennas, printed antennas fabricated on the surface of one or more printed circuit boards, patch antennas, or phased array antennas. The antenna structure 2826 may have one or more panels designed for specific frequency bands including bands in FR1 or FR2.

The user interface 2816 includes various input/output (I/O) devices designed to enable user interaction with the UE 2800. The user interface 2816 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 2800.

The sensors 2820 may include devices, modules, or subsystems whose purpose is to detect events or changes in its environment and send the information (sensor data) about the detected events to some other device, module, or subsystem. Examples of such sensors include inertia measurement units comprising accelerometers, gyroscopes, or magnetometers: microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 2822 may include software and hardware elements that operate to control particular devices that are embedded in the UE 2800, attached to the UE 2800, or otherwise communicatively coupled with the UE 2800. The driver circuitry 2822 may include individual drivers allowing other components to interact with or control various I/O devices that may be present within, or connected to, the UE 2800. For example, the driver circuitry 2822 may include circuitry to facilitate coupling of a UICC (for example, UICC 288) to the UE 2800. For additional examples, driver circuitry 2822 may include a display driver to control and allow access to a display device, a touchscreen driver to control and allow access to a touchscreen interface, sensor drivers to obtain sensor readings of sensors 2820 and control and allow access to sensors 2820, drivers to obtain actuator positions of electro-mechanic components or control and allow access to the electro-mechanic components, a camera driver to control and allow access to an embedded image capture device, audio drivers to control and allow access to one or more audio devices.

The PMIC 2824 may manage power provided to various components of the UE 2800. In particular, with respect to the processors 2804, the PMIC 2824 may control power-source selection, voltage scaling, battery charging, or DC-to-DC conversion.

In some embodiments, the PMIC 2824 may control, or otherwise be part of, various power saving mechanisms of the UE 2800 including DRX as discussed herein.

A battery 2828 may power the UE 2800, although in some examples the UE 2800 may be mounted deployed in a fixed location, and may have a power supply coupled to an electrical grid. The battery 2828 may be a lithium ion battery, a metal-air battery, such as a zinc-air battery, an aluminum-air battery, a lithium-air battery, and the like. In some implementations, such as in vehicle-based applications, the battery 2828 may be a typical lead-acid automotive battery.

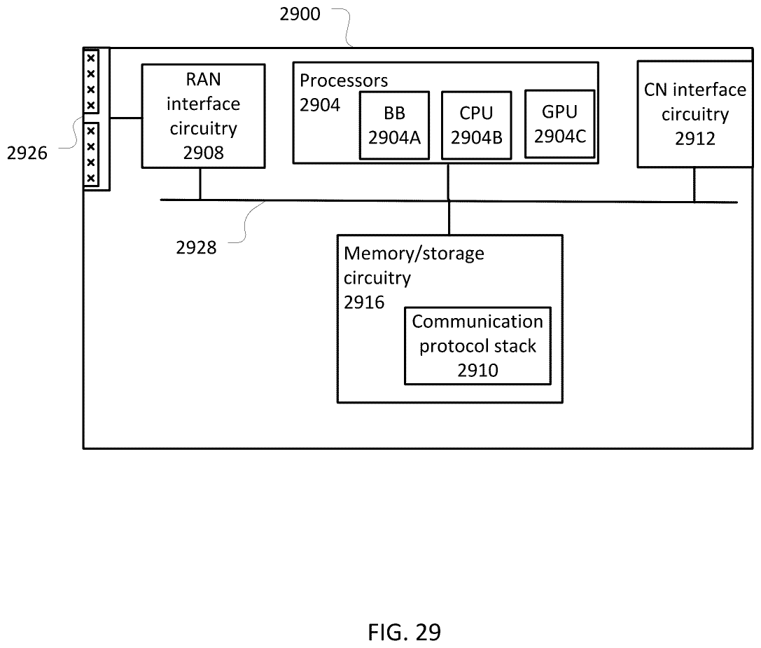

FIG. 29 illustrates a network node 2900 in accordance with some embodiments. The network node 2900 may be similar to and substantially interchangeable with any of the RAN/CN components described herein including, for example, an NFs such as PF 228, CMF, 232, UCRF 216, or MMF 212.

The network node 2900 may include processors 2904, RF interface circuitry 2908, core network (CN) interface circuitry 2912, memory/storage circuitry 2916, and antenna structure 2926.

The components of the network node 2900 may be coupled with various other components over one or more interconnects 2928.

The processors 2904, RF interface circuitry 2908, memory/storage circuitry 2916 (including communication protocol stack 2910), antenna structure 2926, and interconnects 2928 may be similar to like-named elements shown and described with respect to FIG. 28.

The CN interface circuitry 2912 may provide connectivity to a core network, for example, a 5th Generation Core network (5GC) using a compatible network interface protocol such as carrier Ethernet protocols, or some other suitable protocol. Network connectivity may be provided to/from the network node 2900 via a fiber optic or wireless backhaul. The CN interface circuitry 2912 may include one or more dedicated processors or FPGAs to communicate using one or more of the aforementioned protocols. In some implementations, the CN interface circuitry 2912 may include multiple controllers to provide connectivity to other networks using the same or different protocols.

In some embodiments, the network node 2900 may be coupled with transmit receive points (TRPs) using the antenna structure 2926, CN interface circuitry, or other interface circuitry.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more aspects, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary aspects are provided.

Example 1 includes a method of operating a proxy function, the method comprising: receiving, from a base station distributed unit (DU), a message having one or more message containers; performing a successful non-access stratum (NAS) security check on the message; selecting, based on performing the successful NAS security check, one or more network functions as destinations for information from the one or more message containers; and transmitting one or more messages with information from the one or more message containers to the one or more network functions.

Example 2 includes the method of example 1 or some other example herein, wherein the one or more messages containers include: a mobility management (MM) message container that includes first information; and a session management (SM) message container that includes second information.

Example 3 includes the method of example 2 or some other example herein, wherein the one or more messages includes an MM message and an SM message and the method further comprises: transmitting the MM message with the first information to a mobility management function (MMF) of the one or more network functions; and transmitting the SM message with the second information to a session management function (SMF) of the one or more network functions.

Example 4 includes the method of example 3 or some other example herein, further comprising: transmitting the MM message and the SM message in parallel.

Example 5 includes the method of example 2 or some other example herein, wherein the MM message is a registration request message, a deregistration request message, a configuration update command message, an authentication request message, a security mode command message, a service request message, a notification message, or an identity request message.

Example 6 includes the method of example 2 or some other example herein, wherein the SM message is a protocol data unit (PDU) session authentication command message; a user equipment (UE)-requested PDU session message; a UE-requested PDU session modification message; or a UE-requested PDU session release message.

Example 7 includes the method of example 1 or some other example herein, the message is a radio resource control (RRC) transfer message received via an F1 interface.

Example 8 includes method of operating a user equipment context repository (UCRF), the method comprising: receiving a registration request message from a mobility management function (MMF); generating a user equipment (UE) context based on the registration request message; and storing, in the UE context, an indication that a UE is in a registered state.

Example 9 includes the method of example 8 or some other example herein, further comprising: determining that the UE is configured with user plane (UP) resources for active transmission or reception of traffic; and storing an indication that the US in an active substate of the registered state based on said determining.

Example 10 includes the method of example 8 or some other example herein, further comprising: determining that the UE is not configured with user plane (UP) resources for active transmission or reception of traffic; and storing an indication that the US in a non-active substate of the registered state based on said determining.

Example 11 includes the method of example 8 or some other example herein, wherein the UE context comprises two or more of an access stratum context, a registration management context, or a session management context.

Example 12 includes a method of operating a mobility management function (MMF), the method comprising: receiving one or more first mobility management (MM) messages from a proxy function, the one or more first MM messages to include first information from a base station distributed unit (DU) that is coupled with the proxy function over an F1 interface; performing a mobility management operation associated with a user equipment (UE) based on the first information; and transmitting one or more second MM messages to the proxy function, the one or more second MM messages to include second information for the base station DU, wherein the second information is to convey results of the mobility management operation.

Example 13 includes the method of example 12 or some other example herein, wherein: the one or more first MM messages includes a registration request message, a deregistration request message, a configuration update command message, an authentication request message, a security mode command message, a service request message, a notification message, or an identity request message; and the one or more second MM message includes a registration accept message, a deregistration accept message, a configuration update complete message, an authentication response message, a security mode complete message, a service accept message, a notification response message, or an identity response message.

Example 14 includes the method of example 12 or some other example herein, wherein the one or more first MM messages includes a registration request message corresponding to an initial registration of the UE, the one or more second MM messages includes a registration accept message, and the method further comprises: identifying a context repository function (UCRF); transmitting a UE context registration request message that includes an identifier (ID) associated with the UE and requested context type; and receiving a UE context registration response message from the UCRF.

Example 15 includes the method of example 12 or some other example herein, wherein the one or more first MM messages includes a registration request message corresponding to a mobility-triggered registration or handover of the UE, the one or more second MM messages include a registration accept message, and the method further comprises: identifying a new UE context repository function (UCRF); transmitting a UE context retrieve message that includes an identifier (ID) associated with the UE and requested context type; and receiving a UE context from the UCRF.

Example 16 includes the method of example 12 or some other example herein, further comprising: transmitting, to a UE context repository function (UCRF), a subscribe message associated with the UE; and receiving, from the UCRF, a notify message with an indication that a session management (SM) context of the UE has been changed.

Example 17 includes the method of example 12 or some other example herein, further comprising: generating a system information broadcast (SIB) message; and transmitting the SIB message to a base station for transmission within a serving cell of the base station.

Example 18 includes a method of operating a connection management function (CMF), the method comprising: receiving, from a session management function (SMF), a paging message transfer message with an identity of a user equipment (UE); transmitting, to the SMF, a paging message transfer response; and transmitting, to a distributed unit (DU) of a base station, a paging message to be transmitted to the UE.

Example 19 includes the method of example 18 or some other example herein, further comprising: transmitting, to a UE context repository function (UCRF), a subscribe message with respect to the UE; and receiving, from the UCRF, a notify message to provide an indication of an update to a context associated with the UE.

Example 20 includes the method of example 18 or some other example herein, further comprising: enabling transition between a non-active substate and an active substate.

Another example may include one or more non-transitory computer-readable media comprising instructions to cause an electronic device, upon execution of the instructions by one or more processors of the electronic device, to perform one or more elements of a method described in or related to any of examples 1-20, or any other method or process described herein.

Another example may include an apparatus comprising logic, modules, or circuitry to perform one or more elements of a method described in or related to any of examples 1-20, or any other method or process described herein.

Another example may include a method, technique, or process as described in or related to any of examples 1-20, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-20, or portions thereof.

Another example include a signal as described in or related to any of examples 1-20, or portions or parts thereof.

Another example may include a datagram, information element, packet, frame, segment, PDU, or message as described in or related to any of examples 1-20, or portions or parts thereof, or otherwise described in the present disclosure.

Another example may include a signal encoded with data as described in or related to any of examples 1-20, or portions or parts thereof, or otherwise described in the present disclosure.

Another example may include a signal encoded with a datagram, IE, packet, frame, segment, PDU, or message as described in or related to any of examples 1-20, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-20, or portions thereof.

Another example may include a computer program comprising instructions, wherein execution of the program by a processing element is to cause the processing element to carry out the method, techniques, or process as described in or related to any of examples 1-20, or portions thereof.

Another example may include a signal in a wireless network as shown and described herein.

Another example may include a method of communicating in a wireless network as shown and described herein.

Another example may include a system for providing wireless communication as shown and described herein.

Another example may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of aspects to the precise form disclosed. Modifications and variations are possible in light of the above teachings or may be acquired from practice of various aspects.

Although the aspects above have been described in considerable detail, numerous variations and modifications will become apparent to those skilled in the art once the above disclosure is fully appreciated. It is intended that the following claims be interpreted to embrace all such variations and modifications.

What is claimed is:

1. A method of operating a proxy function, the method comprising:
receiving, from a base station distributed unit (DU), a message having one or more message containers;
performing a successful non-access stratum (NAS) security check on the message;
selecting, based on performing the successful NAS security check, one or more network functions as destinations for information from the one or more message containers; and
transmitting one or more messages with information from the one or more message containers to the one or more network functions.

2. The method of claim 1, wherein the one or more messages containers include:
a mobility management (MM) message container that includes first information; and
a session management (SM) message container that includes second information.

3. The method of claim 2, wherein the one or more messages include an MM message and an SM message and the method further comprises:
transmitting the MM message with the first information to a mobility management function (MMF) of the one or more network functions; and
transmitting the SM message with the second information to a session management function (SMF) of the one or more network functions.

4. The method of claim 3, further comprising:
transmitting the MM message and the SM message in parallel.

5. The method of claim 2, wherein the MM message is a registration request message, a deregistration request message, a configuration update command message, an authentication request message, a security mode command message, a service request message, a notification message, or an identity request message.

6. The method of claim 2, wherein the SM message is a protocol data unit (PDU) session authentication command message; a user equipment (UE)-requested PDU session message; a UE-requested PDU session modification message; or a UE-requested PDU session release message.

7. The method of claim 1, the message is a radio resource control (RRC) transfer message received via an F1 interface.

8. One or more non-transitory, computer-readable media having instructions that, when executed, cause a user equipment context repository (UCRF) to:
receive a registration request message from a mobility management function (MMF);
generate a user equipment (UE) context based on the registration request message; and
store, in the UE context, an indication that a UE is in a registered state.

9. The one or more non-transitory, computer-readable media of claim 8, wherein the instructions, when executed, further cause the UCRF to:
determine that the UE is configured with user plane (UP) resources for active transmission or reception of traffic; and
store an indication that the US in an active substate of the registered state based on said determination that the UE is configured with UP resources for active transmission or reception of traffic.

10. The one or more non-transitory, computer-readable media of claim 8, wherein the instructions, when executed, further cause the UCRF to:
determine that the UE is not configured with user plane (UP) resources for active transmission or reception of traffic.

11. The one or more non-transitory, computer-readable media of claim 10, wherein the instructions, when executed, further cause the UCRF to:
store an indication that the UE is in a non-active substate of the registered state based on said determination that the UE is not configured with UP resources for active transmission or reception of traffic.

12. The one or more non-transitory, computer-readable media of claim 8, wherein the UE context comprises two or more of an access stratum context, a registration management context, or a session management context.

13. A mobility management function (MMF) comprising:
interface circuitry; and
processing circuitry, coupled with the interface circuitry, the processing circuitry to
receive, via the interface circuitry, one or more first mobility management (MM) messages from a proxy function, the one or more first MM messages to include first information from a base station distributed unit (DU) that is coupled with the proxy function over an F1 interface;
perform a mobility management operation associated with a user equipment (UE) based on the first information; and
transmit, via the interface circuitry, one or more second MM messages to the proxy function, the one or more second MM messages to include second information for the base station DU, wherein the second information is to convey results of the mobility management operation.

14. The MMF of claim 13, wherein the one or more first MM messages includes a registration request message, a deregistration request message, a configuration update command message, an authentication request message, a security mode command message, a service request message, a notification message, or an identity request message.

15. The MMF of claim 14, wherein the one or more second MM message includes a registration accept message, a deregistration accept message, a configuration update complete message, an authentication response message, a security mode complete message, a service accept message, a notification response message, or an identity response message.

16. The MMF of claim 13, wherein the one or more first MM messages includes a registration request message corresponding to an initial registration of the UE, the one or more second MM messages includes a registration accept message, and the processing circuitry is further to:
identify a context repository function (UCRF);
transmit a UE context registration request message that includes an identifier (ID) associated with the UE and requested context type; and
receive a UE context registration response message from the UCRF.

17. The MMF of claim 13, wherein the one or more first MM messages includes a registration request message corresponding to a mobility-triggered registration or handover of the UE, the one or more second MM messages include a registration accept message, and the processing circuitry is further to:
identify a new UE context repository function (UCRF);
transmit a UE context retrieve message that includes an identifier (ID) associated with the UE and requested context type; and
receive a UE context from the UCRF.

18. The MMF of claim 13, wherein the processing circuitry is further to:
transmit, to a UE context repository function (UCRF), a subscribe message associated with the UE.

19. The MMF of claim 18, wherein the processing circuitry is further to:
receive, from the UCRF, a notify message with an indication that a session management (SM) context of the UE has been changed.

20. The MMF of claim 13, wherein the processing circuitry is further to:
generate a system information broadcast (SIB) message; and
transmit the SIB message to a base station for transmission within a serving cell of the base station.
